(19) United States
(12) Patent Application Publication
(10) Pub. No.: US 2025/0048256 A1
(43) Pub. Date: Feb. 6, 2025

(54) METHOD AND APPARATUS FOR NETWORK ENERGY SAVING

(71) Applicant: FG Innovation Company Limited, Tuen Mun (HK)

(72) Inventors: TZU-WEN CHANG, Taipei (TW); CHIE-MING CHOU, Taipei (TW); YUNG-LAN TSENG, Taipei (TW); YEN-HUA LI, Taipei (TW); CHIA-HSIN LAI, Taipei (TW); CHUN-YEN HSU, Taipei (TW)

(21) Appl. No.: 18/792,026

(22) Filed: Aug. 1, 2024

Related U.S. Application Data
(60) Provisional application No. 63/530,155, filed on Aug. 1, 2023.

(51) Int. Cl. H04W 52/02; H04W 76/28

(52) U.S. Cl. CPC H04W 52/0206; H04W 76/28

(57) ABSTRACT

A method performed by a User Equipment (UE) for Network Energy Saving (NES) is provided. The method receives, from a Base Station (BS), a Radio Resource Control (RRC) message including an NES configuration. The method then determines whether to apply a cell Discontinuous Transmission (DTX) operation, a cell Discontinuous Reception (DRX) operation, or both the cell DTX operation and the cell DRX operation based on the NES configuration.

### CROSS-REFERENCE TO RELATED APPLICATION(S)

The present disclosure claims the benefit of and priority to U.S. Provisional Patent Application Ser. No. 63/530,155, filed on Aug. 1, 2023, entitled “ALIGNMENT BETWEEN CELL-DTX, CELL-DRX, AND DRX IN NR,” the content of which is hereby incorporated herein fully by reference into the present disclosure for all purposes.

### FIELD

The present disclosure is related to wireless communication and, more specifically, to a User Equipment (UE), Base Station (BS), and method for Network Energy Saving (NES) in the wireless communication networks.

### BACKGROUND

Various efforts have been made to improve different aspects of wireless communication for the cellular wireless communication systems, such as the 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the next-generation wireless communication systems.

### SUMMARY

The present disclosure is related to a UE, a BS, and a method for NES in the wireless communication networks.

In a first aspect of the present application, a method performed by a UE for NES is provided. The method includes receiving, from a BS, a Radio Resource Control (RRC) message including an NES configuration; and determining whether to apply a cell Discontinuous Transmission (DTX) operation, a cell Discontinuous Reception (DRX) operation, or both the cell DTX operation and the cell DRX operation based on the NES configuration.

In some implementations of the first aspect, the NES configuration is included in a cell configuration carried by the RRC message. The cell DTX operation, the cell DRX operation, or both the cell DTX operation and the cell DRX operation is/are applied to a cell associated with the cell configuration.

In some implementations of the first aspect, the UE is served by multiple cells, and the cell DTX operation, the cell DRX operation, or both the cell DTX operation and the cell DRX operation is/are applied to one of the cells serving the UE.

In some implementations of the first aspect, the NES configuration includes a set of common parameters applicable to both the cell DTX operation and the cell DRX operation.

In some implementations of the first aspect, the set of common parameters includes an on-duration timer, a cycle, a start offset, and a slot offset.

In some implementations of the first aspect, the method further includes determining a first on-duration period for the cell DTX operation and a second on-duration period for the cell DRX operation based on the set of common parameters.

In some implementations of the first aspect, the NES configuration includes a parameter for indicating whether to apply the cell DTX operation, the cell DRX operation, or both the cell DTX operation and the cell DRX operation.

In a second aspect of the present application, a UE for performing NES is provided. The UE includes at least one processor and at least one non-transitory computer-readable medium that is coupled to the at least one processor and that stores one or more computer-executable instructions. The computer-executable instructions, when executed by the at least one processor, cause the UE to: receive, from a BS, an RRC message including an NES configuration; and determine whether to apply a cell DTX operation, a cell DRX operation, or both the cell DTX operation and the cell DRX operation based on the NES configuration.

In a third aspect of the present application, a BS for performing NES is provided. The BS includes at least one processor and at least one non-transitory computer-readable medium that is coupled to the at least one processor and that stores one or more computer-executable instructions. The computer-executable instructions, when executed by the at least one processor, cause the BS to: transmit, to a UE, an RRC message including an NES configuration. The NES configuration indicates to the UE whether to apply a cell DTX operation, a cell DRX operation, or both the cell DTX operation and the cell DRX operation.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a timing diagram illustrating a DRX operation, according to an example implementation of the present disclosure.

FIG. 2A is a timing diagram illustrating a cell DTX operation, according to an example implementation of the present disclosure.

FIG. 2B is a timing diagram illustrating a cell DRX operation, according to an example implementation of the present disclosure.

FIG. 3A is a flowchart illustrating a method/process for aligning the DRX operation with the cell DTX operation, according to an example implementation of the present disclosure.

FIG. 3B is a flowchart illustrating a method/process for aligning the DRX operation with the cell DTX operation, according to an example implementation of the present disclosure.

FIG. 4 is a diagram illustrating a scenario in which the legacy DRX related parameters and the aligned DRX related parameters are configured, according to an example implementation of the present disclosure.

FIG. 5 is a diagram illustrating a scenario in which the legacy DRX related parameters and multiple sets of aligned DRX related parameters are configured, according to an example implementation of the present disclosure.

FIG. 6 is a flowchart illustrating a method/process performed by a UE for NES, according to an example implementation of the present disclosure.

FIG. 7 is a block diagram illustrating a node for wireless communication, according to an example implementation of the present disclosure.

### DETAILED DESCRIPTION

Some of the abbreviations used in the present disclosure include:

| Abbreviation | Full name |
|---|---|
| 3GPP | 3^{rd} Generation Partnership Project |
| 5G | 5^{th} Generation |
| ACK | Acknowledgment |
| AI-RNTI | Availability Indication RNTI |
| BS | Base Station |
| BWP | Bandwidth Part |
| C-RNTI | Cell RNTI |
| CA | Carrier Aggregation |
| CBRA | Contention Based Random Access |
| CC | Component Carrier |
| CFRA | Contention Free Random Access |
| CG | Configured Grant |
| CHO | Conditional Handover |
| CI-RNTI | Cancellation Indication RNTI |
| CRC | Cyclic Redundancy Check |
| CS-RNTI | Configured Scheduling RNTI |
| CSI | Channel State Information |
| CSI-RS | Channel State Information Reference Signal |
| DC | Dual Connectivity |
| DCI | Downlink Control Information |
| DL | Downlink |
| DM-RS | Demodulation Reference Signal |
| DRB | Data Radio Bearer |
| DRX | Discontinuous Reception |
| DTX | Discontinuous Transmission |
| DU | Distributed Unit |
| E-UTRA | Evolved Universal Terrestrial Radio Access |
| FDD | Frequency Division Duplex |
| FR | Frequency Range |
| HARQ | Hybrid Automatic Repeat Request |
| HARQ-ACK | HARQ Acknowledgement |
| HO | Handover |
| ID | Identifier |
| IE | Information Element |
| INT-RNTI | Interruption RNTI |
| L1/L2/L3 | Layer 1/Layer 2/Layer 3 |
| LCP | Logical Channel Prioritization |
| LTE | Long Term Evolution |
| MAC | Medium Access Control |
| MAC CE | MAC Control Element |
| MCG | Master Cell Group |
| MCS | Modulation and Coding Scheme |
| MN | Master Node |
| NAS | Non Access Stratum |
| NES | Network Energy Saving |
| NG-RAN | Next Generation RAN |
| NR | New Radio |
| NUL | Normal Uplink |
| NW | Network |
| NZP | Non-Zero Power |
| OFDM | Orthogonal Frequency Division Multiplexing |
| PCell | Primary Cell |
| PCI | Physical Cell Identifier |
| PDCCH | Physical Downlink Control Channel |
| PDSCH | Physical Downlink Shared Channel |
| PH | Power Headroom |
| PHY | Physical (layer) |
| PRACH | Physical Random Access Channel |
| PSCell | Primary SCG Cell |
| PUCCH | Physical Uplink Control Channel |
| PUSCH | Physical Uplink Shared Channel |
| QCL | Quasi-colocation |
| QoS | Quality of Service |
| RA | Random Access |
| RACH | Random Access Channel |
| RAN | Radio Access Network |
| RAR | Random Access Response |
| Rel | Release |
| RF | Radio Frequency |
| RLF | Radio Link Failure |
| RNTI | Radio Network Temporary Identifier |
| RRC | Radio Resource Control |
| RS | Reference Signal |
| RSRP | Reference Signal Received Power |
| Rx | Reception |
| SCell | Secondary Cell |
| SCG | Secondary Cell Group |
| SDM | Spatial Division Multiplexing |
| SFI-RNTI | Slot Format Indication RNTI |
| SFN | System Frame Number |
| SI | System Information |
| SIB | System Information Block |
| SL | Sidelink |
| SLCS-RNTI | Sidelink Configured Scheduling RNTI |
| SN | Secondary Node |
| SP-CSI-RNTI | Semi-Persistent CSI RNTI |
| SpCell | Special Cell |
| SPS | Semi-Persistent Scheduling |
| SR | Scheduling Request |
| SRS | Sounding Reference Signal |
| SSB | Synchronization Signal Block |
| SUL | Supplementary Uplink |
| TA | Timing Advance |
| TAG | Timing Advance Group |
| TB | Transport Block |
| TCI | Transmission Configuration Indicator |
| TDD | Time Division Duplex |
| TPC | Transmit Power Control |
| TRP | Transmission Reception Point |
| TR | Technical Report |
| TS | Technical Specification |
| Tx | Transmission |
| UE | User Equipment |
| UL | Uplink |
| URLLC | Ultra-Reliable and Low-Latency Communication |
| V2X | Vehicle to Everything |
| V-RNTI | V2X RNTI |
| XR | eXtended Reality |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and may not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface. Although the gNB is used as an example in some implementations within the present disclosure, it should be noted that the disclosed implementations may also be applied to other types of base stations.

The BS may be operable to provide radio coverage to a specific geographical area using multiple cells forming the RAN. The BS may support the operations of the cells. Each cell may be operable to provide services to at least one UE within its radio coverage.

Each cell (may often referred to as a serving cell) may provide services to one or more UEs within the cell's radio coverage, such that each cell schedules the DL (and optionally UL resources) to at least one UE within its radio coverage for DL (and optionally UL packet transmissions from the UE). The BS may communicate with one or more UEs in the radio communication system via the cells.

A cell may allocate sidelink (SL) resources for supporting the Proximity Services (ProSe) or Vehicle to Everything (V2X) services. Each cell may have overlapped coverage areas with other cells.

In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As discussed above, the frame structure for NR may support flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes may be considered for NR, specifically, Low-Density Parity-Check (LDPC) code and Polar Code. The coding scheme adaption may be configured based on channel conditions and/or service applications.

At least the DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

In some implementations, all the designs/embodiment/implementations introduced within this disclosure are not limited to be applied for dealing with the problems discussed within this disclosure. For example, the described embodiments may be applied to solve other problems that exist in the RAN of wireless communication systems. In some implementations, all of the numbers listed within the designs/embodiment/implementations introduced within this disclosure are just examples and for illustration, for example, of how the described methods are executed.

A DL RRC message in the present disclosure may include, but is not limited to, an RRC reconfiguration message (RRCReconfiguration), an RRC resume message (RRCResume), an RRC reestablishment message (RRCReestablishment), an RRC setup message (RRCSetup) or any other DL unicast RRC message.

In some implementations, “a specific configuration is per UE configured” or “a specific configuration is configured for a UE” described in the present disclosure may represent the specific configuration that is, but is not limited to be, configured within a DL RRC message.

In some implementations, “a specific configuration is per cell group configured” or “a specific configuration is configured for a cell group” described in the present disclosure may represent the specific configuration that is, but is not limited to be, configured within a cell group configuration (e.g., the CellGroupConfig, MAC-CellGroupConfig, or PhysicalCellGroupConfig IE).

In some implementations, “a specific configuration is per serving cell configured” or “a specific configuration is configured for a serving cell” described in the present disclosure may represent the specific configuration that is, but is not limited to be, configured within a serving cell configuration (e.g., the ServingCellConfigCommon, ServingCellConfig, PUSCH-ServingCellConfig, or PDSCH-ServingCellConfig IE).

In some implementations, “a specific configuration is per UL BWP or per BWP configured” or “a specific configuration is configured for a UL BWP or for a BWP” described in the present disclosure may represent the specific configuration that is, but is not limited to be, configured within one of the followings IEs: the BWP-Uplink, BWP-UplinkDedicated, BWP-UplinkCommon, PUSCH-ConfigCommon, and PUSCH-Config.

In some implementations, “a specific configuration is per DL BWP or per BWP configured” or “a specific configuration is configured for a DL BWP or for a BWP” described in the present disclosure may represent the specific configuration that is, but is not limited to be, configured within one of the followings IEs: the BWP-Downlink, BWP-DownlinkDedicated, BWP-DowninkCommon, PDSCH-ConfigCommon, and PDSCH-Config IE.

In some implementations, A PDSCH/PDSCH/PUSCH transmission may span multiple symbols in the time domain. A time duration of a PDSCH/PDSCH/PUSCH (transmission) may imply a time interval that starts from the beginning of the first symbol of the PDSCH/PDSCH/PUSCH (transmission) and ends at the end of the last symbol of the PDSCH/PDSCH/PUSCH (transmission).

The term “A and/or B” within the present disclosure means “A”, “B”, or “A and B”. The term “A and/or B and/or C” within the present disclosure means “A”, “B”, “C”, “A and B”, “A and C”, “B and C”, or “A and B and C”. The term “A/B” within the present disclosure means “A” or “B”.

The term “(specific) PHY layer signaling” may refer to a specific format of the DCI, a specific field of the DCI, a specific field of the DCI with the field being set to a specific value, and/or the DCI with CRC bits scrambled with a specific RNTI.

In the present disclosure, “a MAC timer” may include, but is not limited to, a timer configured by a base station via RRC signaling. The UE may be configured with an initial value of the timer and the unit of the value may include, but is not limited to, frame/sub-frame/milli second/sub-milli second/slot/symbol. The timer may be started and/or restarted by the UE (e.g., by the MAC entity of the UE). The timer may be started and/or restarted by the UE (e.g., by the MAC entity of the UE) when a specific condition is satisfied.

Examples of some selected terms in the present disclosure are provided as follows.

Cell: A radio network object that may be uniquely identified by a User Equipment from a (cell) identification that is broadcast over a geographical area from, for example, a UTRAN Access Point. A Cell is either in an FDD mode or a TDD mode.

Serving Cell: For a UE in the RRC_CONNECTED state, that is not configured with CA/DC, there is only one serving cell including a primary cell. For a UE in the RRC_CONNECTED state, that is configured with CA/DC, the term ‘serving cells’ is used to denote a set of cells including the Special Cell(s) and all secondary cells.

BWP: A subset of the total cell bandwidth of a cell is referred to as a Bandwidth Part (BWP) and a Bandwidth Adaptation (BA) may be achieved by configuring the UE with BWP(s) and instructing the UE which of the configured BWPs is currently the active one. To enable a BA on the PCell, the BS (e.g., a gNB) configures the UE with UL and DL BWP(s). To enable the BA on SCells, when CA is deployed, the BS configures the UE with one or more DL BWPs. It should be noted that there may be no BWP in the UL. For the PCell, the initial BWP is the BWP used for an initial access. For the SCell(s), the initial BWP is the BWP configured for the UE to operate after an SCell activation. The UE may be configured with a first active uplink BWP by a firstActiveUplinkBWP IE. If the first active uplink BWP is configured for an SpCell, the firstActiveUplinkBWP IE field may contain the ID of the UL BWP to be activated upon performing the RRC (re-)configuration. If such a field is absent, the RRC (re-)configuration may not impose a BWP switching. If the first active uplink BWP is configured for an SCell, thefirstActiveUpinkBWP IE field may contain the ID of the uplink bandwidth part to be used upon the MAC-activation of an SCell.

Timer: A MAC entity may set up one or more timers for different purposes, for example, triggering one or more uplink signaling retransmissions or limiting one or more uplink signaling retransmission periods. A timer is running once it is started, until it is stopped, or until it expires; otherwise, the timer is not running. A timer may be started if it is not running, or may be restarted if it is running. A timer is always started or restarted from its initial value. The initial value may be, but is not limited to be, configured by the gNB via downlink RRC signaling or be a pre-defined/pre-determined value addressed in some specifications.

PDCCH: In the downlink, a base station (e.g., a gNB) may dynamically allocate resources to the UEs, at least, via the C-RNTI/MCS-C-RNTI/CS-RNTI on PDCCH(s). A UE always monitors the PDCCH(s) in order to find possible assignments when its downlink reception is enabled (e.g., activities governed by the DRX when configured). When CA is configured, the same C-RNTI may be applied to all serving cells.

PDSCH/PUSCH: The PDCCH may be used to schedule the DL transmissions on a PDSCH, and the UL transmissions on a PUSCH.

DRX group: A group of serving cells configured by RRC signaling to have the same DRX active time may be referred to as a DRX group.

Field: The contents of an information element may be referred to as fields.

Information element: A structural element containing single or multiple fields may be referred to as an information element.

Primary Cell: The MCG cell, operating on the primary frequency, in which the UE either performs the initial connection establishment procedure or initiates the connection re-establishment procedure may be referred to as a primary cell.

Secondary Cell: For a UE configured with CA, a cell that provides additional radio resources on top of the special cell may be referred to as a secondary cell.

Special Cell (SpCell): For a DC operation, the term special cell may refer to the PCell of the MCG or the PSCell of the SCG, otherwise, the term special cell may refer to the PCell.

Timing Advance Group: A group of serving cells that is configured by RRC signaling and that, for the cells with a UL configured, use the same timing reference cell and the same Timing Advance value may be referred to as a timing advance group. A Timing Advance Group including the SpCell of a MAC entity may be referred to as a Primary Timing Advance Group (PTAG), whereas the term Secondary Timing Advance Group (STAG) may refer to other TAGs.

5G is becoming pervasive across multiple industries and geographical areas, handling more advanced services and applications that require very high data rates (e.g., the XR service). To fulfill the requirements of the advanced services and applications, the network may need to provide higher data rate, lower latency, and improved reliability. As a result, networks may be deployed more densely and may use more antennas, larger bandwidths, and more frequency bands. This may, however, lead to a significant environmental impact. To mitigate the environmental impact, there is a need to study and develop a network energy saving (NES) mechanism.

In the 3GPP, several network energy saving techniques in the targeted deployment scenarios are identified. For example, techniques in time domain, such as cell DTX and cell DRX, are introduced. From the network's perspective, a cell-DTX/cell-DRX non-active period may be introduced, where some transmissions/receptions may be limited in the non-active period. Implementations regarding basic operations, configurations, signaling, and other specific impacts of the cell DTX operation and the cell DRX operation are described in detail in the present disclosure. The cell DTX operation may also be referred to as “cell-DTX” or “cell DTX”, and the cell DRX operation may also be referred to as “cell-DRX” or “cell DRX” in the present disclosure.

In some implementations, the UL operations/transmission and DL operations/reception may be occasionally coupled tightly (e.g., the DL reception and its UL HARQ feedback). Allowing the cell DTX and the cell DRX to be misaligned (e.g., with the network in a cell-DTX active period and a cell-DRX non-active period) may induce latency and cause extra signaling between the UEs and the network. This may violate the UE QoS of some services and decrease the desired network's energy-saving. Moreover, configuring the cell DTX and the cell DRX to be aligned may simplify the UE's behavior and may avoid unnecessary and complicated specification. Thus, how to achieve the alignment between the cell TX and the cell DRX are addressed in this disclosure.

In addition, when a UE is configured with a DRX operation (e.g., DRX at the UE), the UE may monitor the PDCCH for the incoming PUSCH/PDSCH transmissions if the UE is in the DRX Active Time. Allowing the cell DTX and the DRX (e.g., the DRX at the UE) to be not aligned (e.g., with the network in the cell-DTX non-active period and the UE in the DRX Active Time) may induce unnecessary UE PDCCH monitoring activities, and may thus increase the UE power consumption. Moreover, as described in the 3GPP TR 38.864 V18.1.0, the alignment between the DRX and the cell DTX may be beneficial. Therefore, how to align the cell DTX and the DRX are also addressed in the present disclosure.

### Carrier Aggregation

In Carrier Aggregation (CA), two or more Component Carriers (CCs) are aggregated. A UE may simultaneously receive or transmit on one or multiple CCs depending on its capabilities.

A UE with single timing advance capability for CA may simultaneously receive and/or transmit on multiple CCs corresponding to multiple serving cells sharing the same timing advance (e.g., multiple serving cells grouped in one TAG).

A UE with multiple timing advance capability for CA may simultaneously receive and/or transmit on multiple CCs corresponding to multiple serving cells with different timing advances (e.g., multiple serving cells grouped in multiple TAGs). The NG-RAN may ensure that each TAG contains at least one serving cell.

A non-CA capable UE may receive on a single CC and transmit on a single CC corresponding to one serving cell only (e.g., one serving cell in one TAG).

CA is supported for both contiguous and non-contiguous CCs. When CA is deployed, the frame timing and SFN may be aligned across cells that are capable of aggregation, or an offset in multiples of slots between the PCell/PSCell and an SCell may be configured to the UE. The maximum number of configured CCs for a UE is 16 for DL and 16 for UL.

Supplementary Uplink: In conjunction with a UL/DL carrier pair (e.g., in an FDD band) or a bidirectional carrier (e.g., in a TDD band), a UE may be configured with additional SULs. The SUL differs from the aggregated uplink in that the UE may be scheduled to transmit either on the SUL or on the uplink of the carrier being supplemented, but not on both at the same time.

When CA is configured, the UE may only have one RRC connection with the network. At the time of the RRC connection establishment/re-establishment/handover, a serving cell may provide the NAS mobility information, and at the time of RRC connection re-establishment/handover, a serving cell may provide the security input. Such a cell may be referred to as the Primary Cell (PCell). Depending on the UE capabilities, Secondary Cells (SCells) may be configured to form, together with the PCell, a set of serving cells. Therefore, the configured set of serving cells for a UE may always include one PCell and one or more SCells.

The reconfiguration, addition, and removal of SCells may be performed by an RRC entity. At an intra-NR handover and during a connection resume from the RRC_INACTIVE state, the network may also add, remove, keep, or reconfigure the SCells to be used with the target PCell. When adding a new SCell, dedicated RRC signaling may be used for sending all the required system information of the SCell. While in the RRC connected mode, the UE may not need to acquire broadcast system information directly from the SCells.

### Discontinuous Reception (DRX)

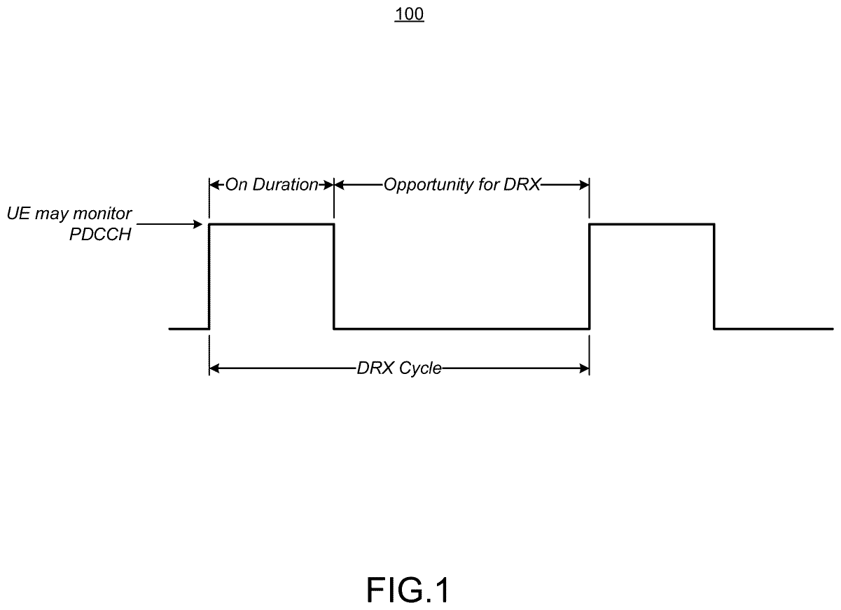

FIG. 1 is a timing diagram 100 illustrating a DRX operation, according to an example implementation of the present disclosure. The MAC entity may be configured by the RRC entity with a DRX functionality that controls the UE's PDCCH monitoring activity for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI and SL Semi-Persistent Scheduling V-RNTI. When the DRX is configured, the UE may not have to continuously monitor the PDCCH. The DRX pattern may be characterized/determined by the following parameters:
on-duration: the period during which the UE waits for, after waking up, to receive the PDCCHs. If the UE successfully decodes a PDCCH, the UE may stay awake and start the inactivity timer.
inactivity-timer: the period during which the UE waits to successfully decode a PDCCH from the last successful decoding of a PDCCH. When the inactivity timer expires without a successful decoding of the PDCCH, the UE may return to sleep. The UE may restart the inactivity timer following a single successful decoding of the PDCCH for a first transmission only (e.g., not for the retransmissions).
retransmission-timer: the time period until a retransmission may be expected.
cycle: this parameter may specify the periodic repetition of the on-duration followed by a possible period of inactivity. As shown in FIG. 1, the DRX cycle may include an on-duration and an opportunity for DRX. For example, the UE may be active or inactive during the opportunity for DRX.
active-time: the total period during which the UE monitors the PDCCH. The active-time may include the on-duration of the DRX cycle, the time during which the UE is performing continuous reception while the inactivity timer has not expired, and the time during which the UE is performing continuous reception while waiting for a retransmission opportunity.

The UE may be configured by the network with a DRX configuration (e.g., the DRX-Config) via RRC signaling, where the DRX configuration may include the following DRX related parameters:
drx-onDurationTimer: the time period at the beginning of a DRX cycle.
drx-SlotOffset: the delay before starting the drx-onDurationTimer.
drx-InactivityTimer: the time period after the PDCCH occasion in which a PDCCH indicates a new UL, DL or SL transmission for the MAC entity.
drx-RetransmissionTimerDL (per DL HARQ process except for the broadcast process): the maximum time period until a DL retransmission is received.
drx-RetransmissionTimerUL (per UL HARQ process): the maximum time period until a grant for UL retransmission is received.
drx-LongCycleStartOffset: the Long DRX cycle and the drx-StartOffset which defines the subframe where the Long and Short DRX cycle starts.
drx-ShortCycle (optional): the Short DRX cycle.
drx-ShortCycle Timer (optional): the time period during which the UE follows the Short DRX cycle.
drx-HARQ-RTT-TimerDL (per DL HARQ process except for the broadcast process): the minimum time period before a DL assignment for HARQ retransmission is expected by the MAC entity.
drx-HARQ-RTT-TimerUL (per UL HARQ process): the minimum time period before a UL HARQ retransmission grant is expected by the MAC entity.

The serving cells of a MAC entity may be configured by RRC signaling in two DRX groups with separate DRX parameters. The UE may be provided by the network with one or more cell configurations (e.g., the SpCellConfig, SCellConfig) that may include a parameter (e.g., the secondaryDRX-GroupConfig) indicating whether the cell belongs to a secondary DRX group. When RRC signaling does not configure a secondary DRX group, there may be only one DRX group and all the serving cells may belong to that one DRX group.

When two DRX groups are configured, each serving cell may be uniquely assigned to either one of the two groups. The DRX parameters that are separately configured for each DRX group may include the drx-onDurationTimer and the drx-Inactivity Timer. The UE may be configured by the network with two DRX configurations (e.g., the DRX-Config and DRX-ConfigSecondaryGroup), where each DRX configuration may include the drx-onDurationTimer and the drx-InactivityTimer. In addition, the DRX configuration (e.g., the DRX-Config) may further include the following DRX parameters that are common to the DRX groups: the drx-SlotOffset, drx-RetransmissionTimerDL, drx-RetransmissionTimerUL, drx-LongCycleStartOffset, drx-ShortCycle (optional), drx-ShortCycle Timer (optional), drx-HARQ-RTT-TimerDL, and drx-HARQ-RTT-TimerUL.

When the DRX is configured, the active time for the serving cells in a DRX group may include the time during which:
the drx-onDurationTimer or drx-InactivityTimer configured for the DRX group is running,
the drx-RetransmissionTimerDL or drx-RetransmissionTimerUL is running on any serving cell in the DRX group,
the ra-ContentionResolutionTimer or msgB-ResponseWindow is running,
a Scheduling Request (SR) is sent on a PUCCH and is pending, or
a PDCCH indicating a new transmission addressed to the C-RNTI of the MAC entity has not been received after a successful reception of a Random Access Response (RAR) for the Random Access Preamble not selected by the MAC entity among the contention-based Random Access Preambles.

The network may indicate to the UE to terminate the active time via MAC signaling (e.g., a MAC CE). In some implementations, if the UE receives a DRX Command MAC CE with the DCI scrambled with C-RNTI for a unicast transmission or a Long DRX Command MAC CE, the UE may stop the drx-onDurationTimer and the drx-InactivityTimer for each DRX group.

When the on-duration ends, the UE may switch from the Long DRX cycle to the Short DRX cycle if the Short DRX cycle is configured. If the drx-InactivityTimer for a DRX group expires and the Short DRX cycle is configured, the UE may start or restart the drx-ShortCycleTimer for this DRX group in the first symbol after the expiry of the drx-InactivityTimer and may use the Short DRX cycle for this DRX group. Otherwise, the UE may use the Long DRX cycle for this DRX group. In addition, the network may indicate to the ULE to activate the Short DRX cycle via a MAC CE. If a DRX Command MAC CE with the DCI scrambled with C-RNTI for unicast transmission is received and the Short DRX cycle is configured, the UE may start or restart the drx-ShortCycle Timer for each DRX group in the first symbol after the end of DRX Command MAC CE reception and may use the Short DRX cycle for each DRX group. Otherwise, the UE may use the Long DRX cycle for each DRX group. In addition, if the drx-ShortCycle Timer for a DRX group expires, the UE may use the Long DRX cycle for this DRX group.

When the Short DRX cycle is used, the UE may be indicated by the network via a MAC CE to switch from the Short DRX cycle to the Long DRX cycle. If a Long DRX Command MAC CE is received, the UE may stop the drx-ShortCycleTimer for each DRX group and use the Long DRX cycle for each DRX group.

The UE may determine when to start the on-duration timer during a Long/Short DRX cycle. If the Short DRX cycle is used for a DRX group, and [(SFN×10)+subframe number]modulo (drx-ShortCycle)=(drx-StartOffset) modulo (drx-ShortCycle), the UE may start the drx-onDurationTimer for this DRX group after the drx-SlotOffset from the beginning of the subframe. In addition, if the Long DRX cycle is used for a DRX group, and [(SFN×10)+subframe number]modulo (drx-LongCycle)=drx-StartOffset, the UE may start the drx-onDurationTimer for this DRX group after the drx-SlotOffset from the beginning of the subframe.

When a DRX group is in the active time, the UE may monitor the PDCCH on the serving cells in this DRX group. If the PDCCH indicates a new transmission (DL or UL) on a serving cell in this DRX group, the UE may start or restart the drx-InactivityTimer for this DRX group in the first symbol after the end of the PDCCH reception.

### Cell DTX and Cell DRX

To reduce the active time for downlink transmission/uplink reception of a base station (e.g., a gNB), the UE may be configured with one or more cell-DTX and/or cell-DRX pattern (e.g., for indicating active and non-active periods). The pattern configuration for the cell-DTX/cell-DRX may be common for the UEs configured with such a feature in the cell (e.g., a cell-specific cell-DTX pattern and/or a cell-specific cell-DRX pattern). The cell-DTX pattern and the cell-DRX pattern may be configured separately.

When the cell DTX operation is configured for/by a cell, the UE may not monitor the PDCCH or SPS PDSCH occasions during the cell-DTX non-active period.

When the cell DRX operation is configured for/by a cell, the UE may not transmit on the CG PUSCH resources and/or may not transmit any SR during the cell-DRX non-active period.

This feature (e.g., the cell DRX operation and/or the cell DRX operation) may be only applied to the UEs that are in the RRC_CONNECTED state, and it may not impact the RA procedure, SSB transmission, paging, and system information broadcasting, where the RA procedure may be a 4-step, 2-step, CBRA, and/or CFRA procedure.

Once the network recognizes that there is an emergency call or a public safety related service (e.g., the Multimedia Priority Service (MPS) or Mission Critical Service (MCS)), the network may ensure that there is no impact on that service. For example, the network may release or deactivate the cell-DTX and/or cell-DRX configuration.

### Cell-DTX Pattern

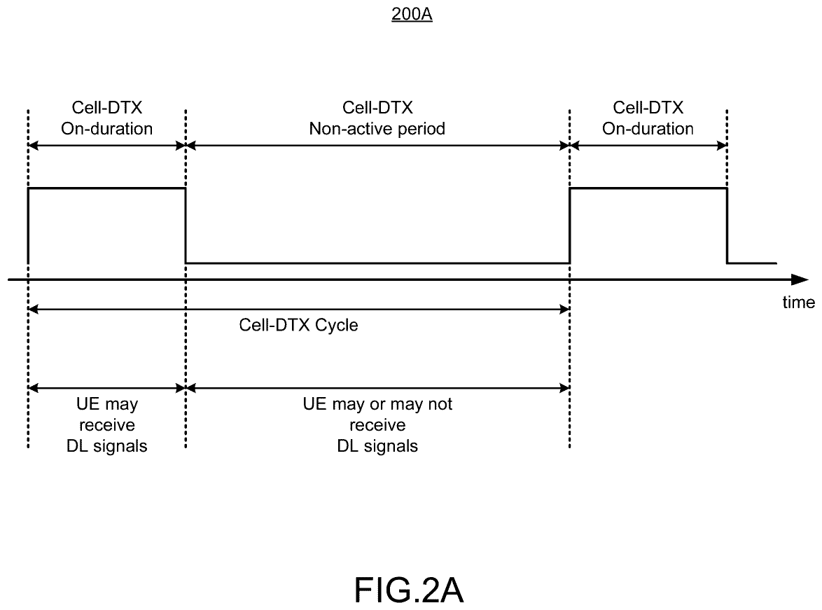

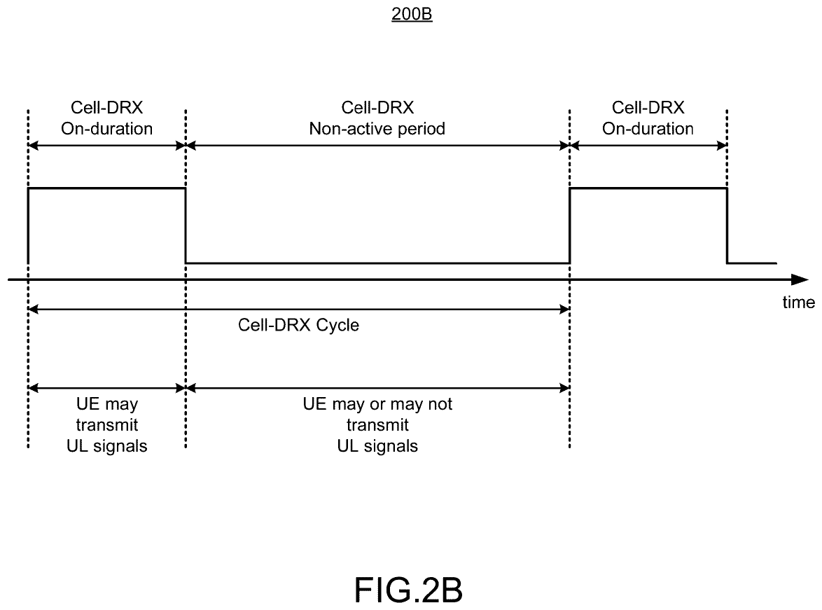

FIG. 2A is a timing diagram 200A illustrating a cell DTX operation, according to an example implementation of the present disclosure. The MAC entity may be configured by RRC signaling with a cell-DTX functionality that controls the UE's PDCCH monitoring and PDSCH activities for the UE-specific/group-common RNTIs (e.g., the C-RNTI, CS-RNTI, etc.). When the cell-DTX is configured and/or activated, the UE may suspend/skip/stop the PDCCH monitoring and/or PDSCH receptions. The periodic cell-DTX pattern may be characterized by the following parameters:
Cell-DTX on-duration period: the time period during which the UE may be expected/configured to receive the PDCCH/PDSCH.
Cell-DTX non-active period: the time period during which the UE may not be expected (or may not be configured) to receive the PDCCH/PDSCH, even if the UE is scheduled with the corresponding PDCCH/PDSCH resources.
Cell-DTX cycle: this parameter may specify the periodic repetition of the cell-DTX on-duration period. As shown in FIG. 2A, the cell-DTX cycle may include the cell-DTX on-duration period and the cell-DTX non-active period.

### Cell-DRX Pattern

FIG. 2B is a timing diagram 200B illustrating a cell DRX operation, according to an example implementation of the present disclosure. The MAC entity may be configured by RRC signaling with a cell-DRX functionality that controls the UE's PUCCH/PUSCH activities. When the cell-DRX is configured and/or activated, the UE may suspend/skip/stop the UL transmissions on the PUCCH/PUSCH. The periodic cell-DRX pattern may be characterized by the following parameters:
Cell-DRX on-duration period: the time period during which the UE may (expect to) transmit the PUCCH/PUSCH.
Cell-DRX non-active period: the time period during which the UE may not transmit the PUCCH/PUSCH even if the UE is granted the corresponding PUCCH/PUSCH resources.
Cell-DRX cycle: this parameter may specify the periodic repetition of the cell-DRX on-duration period. As shown in FIG. 2B, the cell-DRX cycle may include the cell-DRX on-duration period and the cell-DRX non-active period.

### Signaling During the Cell-DTX/Cell-DRX Active/Non-Active Period

In some implementations, when the UE is configured with the (DL) SPS for a serving cell (or jointly for one or more serving cells), if an SPS downlink assignment occurs during the cell-DTX non-active period, the UE may ignore the downlink assignment. In other words, the UE may monitor an SPS PDSCH occasion if the SPS PDSCH occasion does not overlap with the cell-DTX non-active period.

In some implementations, when the UE is configured with the (DL) SPS for a serving cell, if the cell-DTX on-duration timer expires, indicating that the cell will enter the cell-DTX non-active period, the UE may deactivate the SPS.

In some implementations, when an SPS PDSCH occasion partially overlaps with a cell-DTX non-active period (e.g., in time domain), the UE may ignore the entire SPS PDSCH occasion.

In some implementations, the base station may further provide an instruction (e.g., through an RRC configuration) to indicate whether the UE should ignore the SPS PDSCH occasion or not when there is an overlapped period, where the SPS PDSCH occasion may fully or partially overlap in the overlapped period. The instruction may be configured per SPS configuration/CS-RNTI/cell/DL BWP.

When the UE is configured with a parameter pdsch-AggregationFactor >1, the parameter pdsch-AggregationFactor may indicate the number of transmissions of a TB within a bundle of a dynamic downlink assignment and/or an SPS downlink assignment. After the initial transmission, the pdsch-AggregationFactor −1 HARQ retransmissions may follow within the bundle.

In some implementations, if the PDSCH occasion for the initial transmission and/or HARQ retransmissions fully or partially overlaps with the cell-DTX non-active period, the UE may ignore the PDSCH occasion. In other words, the UE may monitor a PDSCH occasion for the initial transmission and/or HARQ retransmissions within the bundle if the PDSCH occasion does not overlap with the cell-DTX non-active period.

In some implementations, when a PDSCH scheduled by a dynamic DL assignment fully or partially overlaps with the cell-DTX non-active period, the UE may monitor the PDSCH to receive the DL assignment. The dynamic DL assignment may be provided by a PDCCH during the cell-DTX active period or the cell-DTX non-active period. Afterward, the UE may transmit a DL HARQ feedback on a PUCCH/PUSCH that may or may not overlap with the cell-DRX non-active period.

In some implementations, when the UE is configured with the (UL) CG type 1 for a cell, if a configured UL grant occurs during the cell-DRX non-active period for the cell, the UE may ignore the configured UL grant. “The configured UL grant occurs during the cell-DRX non-active period” means that the PUSCH occasion scheduled by the UL grant may fully or partially overlap with the cell-DRX non-active period.

In some implementations, when the UE is configured with the (UL) CG type 2 for a cell and the CG type 2 is activated, if a configured UL grant occurs during the cell-DRX non-active period for the cell, the UE may ignore the configured UL grant. “The configured UL grant occurs during the cell-DRX non-active period” means that the PUSCH occasion scheduled by the UL grant may fully or partially overlap with the cell-DRX non-active period.

In some implementations, when the UE is configured with the (UL) CG type 1 or type 2 for the NUL carrier (e.g., a non-supplementary uplink carrier), if the configured UL grant occurs during the cell-DRX non-active period for the SUL, the UE may transmit the PUSCH scheduled by the configured UL grant.

In some implementations, when the UE is configured with the (UL) CG type 1 or type 2 for the NUL carrier, if the configured UL grant occurs during the cell-DRX non-active period for the NUL, the UE may ignore the configured UL grant.

In some implementations, when the UE is configured with the (UL) CG type 1 or type 2 for the SUL carrier, if the configured UL grant occurs during the cell-DRX non-active period for the NUL, the UE may transmit the PUSCH scheduled by the configured UL grant.

In some implementations, when the UE is configured with the (UL) CG type 1 or type 2 for the SUL carrier, if the configured UL grant occurs during the cell-DRX non-active period for the SUL, the UE may ignore the configured UL grant.

In some implementations, for a pending SR, when the UE is configured with valid PUCCH resources for the pending SR, the UE (e.g., the MAC entity of the UE) may instruct the PHY to transmit the SR on a valid PUCCH resource for the SR if the PUCCH resource for the SR transmission occasion does not overlap with the cell-DRX non-active period.

In some implementations, when a PUSCH scheduled by a dynamic UL grant fully or partially overlaps with the cell-DRX non-active period, the UE may perform a UL transmission using the UL grant. The dynamic UL grant may be provided by a PDCCH during the cell-DTX active period or the cell-DTX non-active period.

In some implementations, the UL grant discussed in the present disclosure may be scheduled/configured/included in a bundle of dynamic grants or configured grants.

In some implementations, the LCP restriction may be applied or may be additionally configured to specify which DRBs may keep monitoring the PDCCH if the UE receives the cell-DRX/cell-DTX configuration and/or the cell-DTX/cell-DRX is activated.

In some implementations, the UE may implicitly disable the HARQ process when the UE receives the cell-DRX/cell-DTX configuration and/or the cell-DTX/cell-DRX is activated.

### Configurations for Cell-DTX and Cell-DRX

### Parameters

To configure the cell-DTX/cell-DRX pattern, the UE may be configured by the network (e.g., serving RAN/serving cell/serving base station/serving gNB/serving eNB) with the following cell-DTX/cell-DRX related parameters (e.g., per cell) via RRC signaling:
Cell-DTX on-duration timer (e.g., the celldtx-onDurationTimer) may specify the on-duration that is set at the beginning of a cell-DTX cycle, where the timer may be configured in multiples of 1/32 milliseconds (sub-milliseconds) or in milliseconds (ms).
Cell-DTX cycle (e.g., the celldtx-Cycle) and cell-DTX start offset (e.g., the celldtx-StartOffset) may define the subframe where the cell-DTX cycle starts. The cell-DTX cycle may be configured in ms and the cell-DTX start offset may be configured in multiples of 1 ms.
Cell-DTX slot offset (e.g., the celldtx-SlotOffset) may specify a delay before starting the cell-DTX on-duration timer, where the delay may be configured in multiples of 1/32 ms.
Cell-DRX on-duration timer (e.g., the celldrx-onDurationTimer) may specify the on-duration that is set at the beginning of a cell-DRX cycle, where the timer may be configured in multiples of 1/32 milliseconds (sub-milliseconds) or in milliseconds (ms).
Cell-DRX cycle (e.g., the celldrx-Cycle) and cell-DRX start offset (e.g., the celldrx-StartOffset) may define the subframe where the cell-DRX cycle starts. The cell-DRX cycle may be configured in ms and the cell-DRX start offset may be configured in multiples of 1 ms.
Cell-DRX slot offset (e.g., the celldrx-SlotOffset) may specify a delay before starting the cell-DRX on-duration timer, where the delay may be configured in multiples of 1/32 ms.

Moreover, the UE may be configured by the network with the cell-DTX related parameters, the cell-DRX related parameters, and/or some common parameters for both the cell DTX operation and the cell DRX operation. In some implementations, the UE may be configured with a set of common parameters applicable to both the cell DTX operation and the cell DRX operation. The set of common parameters may include at least one of an on-duration timer, a cycle, a start offset, and a slot offset.

In some implementations, the UE may be configured with a first set of parameters for the cell DTX operation and a second set of parameters for the cell DRX operation. In some implementations, to make the cell-DTX pattern and the cell-DTX pattern aligned, the corresponding parameters in the first set and the second set of parameters may be configured with the same values. The first set of parameters may include at least one of a cell-DTX on-duration timer, a cell-DTX cycle, a cell-DTX start offset, and a cell-DTX slot offset. The second set of parameters may include at least one of a cell-DRX on-duration timer, a cell-DRX cycle, a cell-DRX start offset, and a cell-DRX slot offset.

In some implementations, a common field (e.g., a common IE in a UE-specific/group-based RRC message or broadcasting system information) may be used to configure the cell DRX operation and the cell DTX operation. For example, the base station may transmit, to the UE, an RRC message including the common field applicable to both the cell DTX operation and the cell DRX operation. The common field may include at least one of an on-duration timer, a cycle, a start offset, and a slot offset.

In some implementations, the field of some cell-DTX/cell-DRX related parameters may be absent.

In some implementations, the UE may be configured with a first parameter for the cell DTX operation and a second parameter for the cell DRX operation. If a field of the first parameter is absent, to make the cell-DTX pattern and the cell-DRX pattern aligned, the UE may use a corresponding field of the second parameter for the first parameter. The first parameter may include a cell-DTX on-duration timer, a cell-DTX cycle, a cell-DTX start offset, and a cell-DTX slot offset. The second parameter may include a cell-DRX on-duration timer, a cell-DRX cycle, a cell-DRX start offset, and a cell-DRX slot offset. For example, if the cell-DTX start offset of the first parameter is absent, the UE may use the value of the cell-DRX start offset of the second parameter as the cell-DTX start offset.

In some implementations, the UE may be configured with a first parameter for the cell DTX operation and a second parameter for the cell DRX operation. If a field of the second parameter is absent, to make the cell-DTX pattern and the cell-DRX pattern aligned, the UE may use a corresponding field of the first parameter for the second parameter. The first parameter may include a cell-DTX on-duration timer, a cell-DTX cycle, a cell-DTX start offset, and a cell-DTX slot offset. The second parameter may include a cell-DRX on-duration timer, a cell-DRX cycle, a cell-DRX start offset, and a cell-DRX slot offset. For example, if the cell-DRX cycle of the second parameter is absent, the UE may use the value of the cell-DTX cycle of the first parameter as the cell-DRX cycle.

In some implementations, a common default value may be applied if either a cell-DRX related parameter or a cell-DTX related parameter is absent. For example, a common default value for an on-duration timer may be applied to the cell-DTX on-duration timer and the cell-DRX on-duration timer if either one is absent. In some implementation, separate default values may be applied respectively if either a cell-DRX related parameter or a cell-DTX related parameter is absent. For example, a first default value may be applied the cell-DTX on-duration timer if the field for the cell-DTX on-duration timer is absent, and a second default value different from the first default value may be applied to the cell-DRX on-duration timer if the field for the cell-DRX on-duration timer is absent.

In some implementations, default values (e.g., either common default values or separate default values) for cell-DTX/cell-DRX related parameters may be configured in a cell configuration for a primary cell. If a cell-DTX/cell-DRX related parameter for a non-primary cell (e.g., an SCell) is absent, the UE may apply the default value configured for the primary cell.

In some implementations, for a serving cell, the UE may be configured with either the cell-DTX related parameters or the cell-DRX related parameters. When either the cell-DTX related parameters or the cell-DRX related parameters are configured, the configured parameters may be referred as the generic/common parameters that may be used to configure both cell-DTX and cell-DRX.

### Granularity of Configurations

The cell-DTX/cell-DRX related parameters may be provided/included in a newly introduced configuration for the cell DTX operation and/or the cell DRX operation (e.g., cellDTX-Config, cellDRX-Config). This newly introduced configuration may be signaled via an RRC message (e.g., the RRCReconfiguration, RRCSetup, etc.) or via a new SIB that may be designed specifically for the network energy saving (NES). For example, the configuration for the cell DTX operation and the cell DRX operation may be included in an NES configuration carried in an RRC message.

In some implementations, the newly introduced configuration (e.g., the NES configuration) may be included in a cell configuration (e.g., the SpCellConfig, SCellConfig) for a primary cell or a secondary cell, indicating that the cell DTX operation and the cell DRX operation may be used/activated for the primary or secondary cell associated with the cell configuration. The cell configuration may be included in a cell group (e.g., MCG or SCG) configuration or another cell group specified by the serving RAN.

In some implementations, for a cell configured with both NUL and SUL, the newly introduced configuration (e.g., the NES configuration) for the cell DRX operation may be configured in the NUL configuration and/or SUL configuration, indicating that the cell DRX operation may be configured or activated specifically for the NUL and/or SUL, respectively.

For example, if the newly introduced configuration for the cell DRX operation is included in an NUL configuration (e.g., the UplinkConfig), the cell DRX operation may be activated for the NUL on the cell; otherwise, the cell DRX operation may not be activated for the NUL on the cell. If the newly introduced configuration for the cell DRX operation is included in an SUL configuration (e.g., the supplementaryUplinkConfig), the cell DRX operation may be activated for the SUL on the cell; otherwise, the cell DRX operation may not be activated for the SUL on the cell.

In some implementations, the UE may be configured with another indicator for indicating that whether the cell-DRX related parameters may be implemented on the NUL carrier, the SUL carrier, or both. In some implementations, the UE may apply the received cell-DRX related parameters for the NUL/SUL based on whether the UE is allowed/authorized/instructed to access the NUL/SUL carrier.

### Activation/Deactivation for Cell-DTX and Cell-DRX

The UE may be configured with the cell-DTX related parameters and the cell-DRX related parameters. The cell DTX operation and the cell DRX operation may be configured separately. In some implementations, one of the cell DTX operation or the cell DRX operation may be configured. The UE may be configured with either cell-DTX or cell-DRX related parameters. Once the cell DTX operation and/or the cell DRX operation are configured, the cell DTX operation and the cell DRX operation may be activated/deactivated dependently or independently. For example, issues addressed for the cell-DTX/cell-DRX activation/deactivation may include: how to activate/deactivate the cell DTX operation and the cell DRX operation independently when both the cell DTX operation and the cell DRX operation are configured, how to activate/deactivate the cell DTX operation and the cell DRX operation dependently when both the cell DTX operation and the cell DRX operation are configured, and how to activate/deactivate the cell DTX operation and the cell DRX operation dependently when either the cell DTX operation or the cell DRX operation is configured (e.g., a set of common parameters is configured).

### Separate Configurations for Cell-DTX and Cell-DRX

In some implementations, the cell DTX operation and the cell DRX operation may be configured separately. When the cell DTX operation is configured (e.g., the cell-DTX related parameters are configured) for a serving cell, the UE may activate/deactivate the cell DTX operation for the cell regardless of the activation/deactivation of the cell DRX operation (e.g., regardless of whether the cell DRX operation for the serving cell is configured, activated, or deactivated).

In some implementations, when the UE receives an RRC message including the cell-DTX related parameters configured for a serving cell, the UE may activate (e.g., immediately) the cell DTX operation for the serving cell. In some implementations, when the UE receives an RRC message including the cell-DTX related parameters configured for a serving cell, the UE may apply the cell-DTX related parameters and activate (e.g., immediately) the cell-DTX/cell-DRX for all the serving/activated serving cells configured by the serving RAN. The serving cell may be a special cell or a secondary cell of the UE.

In some implementations, when the UE receives an RRC message instructing the UE to release the cell-DTX related parameters for a cell, the UE may deactivate (e.g., immediately) the cell DTX operation for the cell.

In some implementations, when the cell DTX operation is configured for a cell, the UE may be indicated to activate/deactivate the cell DTX operation for the cell via PHY/Layer-1 signaling (e.g., DCI via PDCCH reception). The PHY signaling may be group-common DCI (e.g., via a group-common PDCCH) with CRC scrambled by a common RNTI, and/or UE-specific DCI (e.g., via a UE-specific PDCCH) with CRC scrambled by a UE-specific RNTI. The UE may not be expected to transmit the HARQ-ACK corresponding to the PHY signaling (e.g., the group-common DCI or UE-specific DCI).

If the cell DTX operation for the (serving/configured) cell is activated/deactivated by the PHY signaling, the UE may apply the cell-DTX activation/deactivation for the cell at the beginning of the first slot which is at least a specific time period (e.g., multiple slots/symbols or n milliseconds) after the last symbol of the PDCCH reception providing the cell-DTX activation/deactivation.

If the cell DTX operation for the cell is activated/deactivated by the PHY signaling, the UE may apply the cell-DTX activation/deactivation for the cell after a specific time duration/offset (e.g., multiple slots or a time period configured by RRC signaling) after the UE transmits a HARQ-ACK corresponding to the PDCCH reception providing the cell-DTX activation/deactivation.

In some implementations, when the cell DTX operation is configured for a cell, the UE may be indicated to activate/deactivate the cell DTX operation for the cell via MAC signaling. The MAC signaling may include an existing MAC CE or a newly introduced MAC CE (e.g., a cell-DTX Activation/Deactivation MAC CE).

If the cell DTX operation for the cell is activated/deactivated by a MAC CE, the UE may apply the cell-DTX activation/deactivation for the cell after a specific duration/time offset (e.g., multiple slots or a time period configured by RRC signaling) after the UE transmits a HARQ-ACK corresponding to the PDSCH carrying the MAC CE.

In some implementations, when the cell DRX operation is configured (e.g., the cell-DRX related parameters are configured) for a serving cell/NUL/SUL, the UE may be indicated to activate/deactivate the cell DRX operation for the cell/NUL/SUL, regardless of activation/deactivation of the cell DTX operation (e.g., regardless of whether the cell DTX operation for the serving cell is configured, activated, or deactivated). In some implementations, the UE may activate the cell DRX operation directly after receiving the RRC signaling that carries the cell-DRX related parameters.

In some implementations, when the UE receives an RRC message including the cell-DRX related parameters configured for a serving cell/NUL/SUL, the UE may activate (e.g., immediately) the cell DRX operation for the serving cell/NUL/SUL. In some implementations, when the UE receives an RRC message including the cell-DRX related parameters configured for a serving cell/NUL/SUL, the UE may apply the cell-DRX related parameters and activate (e.g., immediately) the cell-DTX/cell-DRX for all the serving/activated serving cells/NUL/SUL configured by the serving RAN. The serving cell may be a special cell or a secondary cell of the UE.

In some implementations, when the UE receives an RRC message instructing the UE to release the cell-DRX related parameters for a cell/NUL/SUL, the UE may deactivate (e.g., immediately) the cell DRX operation for the cell/NUL/SUL.

In some implementations, when the cell DRX operation is configured for a cell/NUL/SUL, the UE may be indicated to activate/deactivate the cell DRX operation for the cell/NUL/SUL via PHY signaling. The PHY signaling may be group-common DCI (e.g., via a group-common PDCCH) with CRC scrambled by a common RNTI, and/or UE-specific DCI (e.g., via a UE-specific PDCCH) with CRC scrambled by a UE-specific RNTI. The UE may not be expected to transmit the HARQ-ACK corresponding to the PHY signaling (e.g., the group-common DCI or UE-specific DCI).

If the cell DRX operation for the cell is activated/deactivated by the PHY signaling, the UE may apply the cell-DRX activation/deactivation for the cell at the beginning of the first slot which is at least a specific time period (e.g., multiple slots/symbols or n milliseconds) after the last symbol of the PDCCH reception providing the cell-DRX activation/deactivation.

If the cell DRX operation for the cell is activated/deactivated by the PHY signaling, the UE may apply the cell-DRX activation/deactivation for the cell after a specific time period (e.g., multiple slots or a time period configured by RRC signaling) after the UE transmits a HARQ-ACK corresponding to the PDCCH reception providing the cell-DRX activation/deactivation.

In some implementations, when the cell DRX operation is configured for a cell/NUL/SUL, the UE may be indicated to activate/deactivate the cell DRX operation for the cell via MAC signaling. The MAC signaling may include an existing MAC CE or a newly introduced MAC CE (e.g., a cell-DRX Activation/Deactivation MAC CE).

If the cell DRX operation for the cell is activated/deactivated by the MAC CE, the UE may apply the cell-DRX activation/deactivation for the cell after a specific time period (e.g., multiple slots or a time period configured by RRC signaling) after the UE transmits a HARQ-ACK corresponding to the PDSCH carrying the MAC CE.

In some implementations, when both the cell DTX operation and the cell DRX operation are configured for a serving cell (e.g., the cell-DTX related parameters and the cell-DRX related parameters are configured for the cell), the UE may be indicated to activate/deactivate both the cell DTX operation and the cell DRX operation for the cell.

In some implementations, when both the cell DTX operation and the cell DRX operation are configured for a cell, once the cell DTX operation is activated/deactivated for the cell, the UE may activate/deactivate the cell DRX operation for the cell as well. In some implementations, when both the cell DTX operation and the cell DRX operation are configured for a cell, once the cell DRX operation is activated/deactivated for the cell, the UE may activate/deactivate the cell DTX operation for the cell as well.

In some implementations, when both the cell DTX operation and the cell DRX operation are configured for a cell, once the cell DTX operation is activated/deactivated for the cell, the UE may be indicated whether to activate/deactivate the cell DRX operation for the cell as well. The indication may be a 1-bit parameter provided in an RRC message/DCI/MAC CE. For example, when both the cell DTX operation and the cell DRX operation are configured for a cell, once the cell DTX operation is activated, the UE may activate the cell DRX operation if the 1-bit parameter is present or set to 1, and the UE may not activate the cell DRX operation if the 1-bit parameter is absent or set to 0.

In some implementations, when both the cell DTX operation and the cell DRX operation are configured for a cell, once the cell DRX operation is activated/deactivated for the cell, the UE may be indicated whether to activate/deactivate the cell DTX operation for the cell as well. The indication may be a 1-bit parameter provided in an RRC message/DCI/MAC CE. For example, when both the cell DTX operation and the cell DRX operation are configured for a cell, once the cell DRX operation is activated, the UE may activate the cell DTX operation if the 1-bit parameter is present or set to 1, and the UE may not activate the cell DTX operation if the 1-bit parameter is absent or set to 0.

Single Configuration for Cell-DTX and/or Cell-DRX

In some implementations, the UE may be configured with the cell-DTX related parameters and/or the cell-DRX related parameters for a serving cell. Once the cell DTX operation and/or the cell DRX operation is configured, the activation/deactivation may be applied/indicated afterward.

In some implementations, when either the cell DTX operation or the cell DRX operation is configured, the UE may determine whether to activate/deactivate the cell DTX operation, the cell DRX operation, or both. In some implementations, when either the cell DTX operation or the cell DRX operation is configured, once the cell DTX operation is activated, the UE may determine whether the cell DRX operation should be activated/deactivated as well. Similarly, when either the cell DTX operation or the cell DRX operation is configured, once the cell DRX operation is activated, the UE may determine whether the cell DTX operation should be activated/deactivated as well.

In some implementations, when the UE is configured via RRC signaling with the cell-DTX related parameters, once the cell DTX operation is activated, the UE may activate the cell DRX operation using the cell-DTX related parameters. Similarly, when the UE is configured via RRC signaling with the cell-DRX related parameters, once the cell DRX operation is activated, the UE may activate the cell DTX operation using the cell-DRX related parameters. The UE may determine an on-duration period for the cell DTX operation and an on-duration period for the cell DRX operation, according to a common/generic set of parameters.

In some implementations, when the UE is configured via RRC signaling with the cell-DTX related parameters, once the cell DTX operation is deactivated, the UE may deactivate the cell DRX operation as well. Similarly, when the UE is configured via RRC signaling with the cell-DRX related parameters, once the cell DRX operation is deactivated, the UE may deactivate the cell DTX operation as well.

In some implementations, the UE may be indicated to apply/activate/deactivate both the cell DTX operation and the cell DRX operation when a common/generic set of parameters for the cell DTX operation and the cell DRX operation is configured. The set of parameters may be the cell-DTX related parameters, the cell-DRX related parameters, or common/generic parameters for both the cell DTX operation and the cell DRX operation.

When the cell DTX operation is activated, the UE may be provided with a 1-bit parameter via an RRC message/MAC CE/DCI. If the 1-bit parameter is set to a particular value (e.g., 1) representing both the cell DTX operation and the cell DRX operation, the UE may activate/deactivate the cell DRX operation once the cell DTX operation is activated/deactivated; otherwise, the UE may deactivate the cell DRX operation once the cell DTX operation is activated.

When the cell DRX operation is activated, the UE may be provided with a 1-bit parameter via an RRC message/MAC CE/DCI. If the 1-bit parameter is set to a particular value (e.g., 1) representing both the cell DTX operation and the cell DRX operation, the UE may activate/deactivate the cell DTX operation once the cell DRX operation is activated/deactivated; otherwise, the UE may deactivate the cell DTX operation once the cell DRX operation is activated.

In some implementations, the UE may activate/deactivate either the cell DTX operation or the cell DRX operation when a common/generic set of parameters for the cell DTX operation and the cell DRX operation is configured. When a common/generic set of parameters for the cell DTX operation and the cell DRX operation is configured, if the UE is configured/indicated to activate the cell DTX operation, the UE may deactivate the cell DRX operation and then activate the cell DTX operation. When a common/generic set of parameters for the cell DTX operation and the cell DRX operation is configured, if the UE is configured/indicated to activate the cell DRX operation, the UE may deactivate the cell DTX operation and then activate the cell DRX operation.

In some implementations, the UE may be indicated to apply/activate/deactivate the cell DTX operation, the cell DRX operation, or both when a common/generic set of parameters for the cell DTX operation and the cell DRX operation is configured.

In some implementations, the indication may be a parameter signaled via an RRC message/MAC CE/DCI. For example, the UE may determine whether to apply the cell DTX operation, the cell DRX operation, or both based on the indication. In some implementations, the UE may receive an RRC message including an NES configuration from a base station. The NES configuration may include the common/generic set of parameters for the cell DTX operation and the cell DRX operation. The UE may determine whether to apply the cell DTX operation, the cell DRX operation, or both based on the NES configuration. In some implementations, the NES configuration may include a parameter for indicating whether to apply the cell DTX operation, the cell DRX operation, or both.

In some implementations, the indication may be a 1-bit parameter signaled via an RRC message/MAC CE/DCI. If the field of the 1-bit parameter is absent, the UE may be expected to activate both the cell DTX operation and the cell DRX operation using the same set of parameters, and may be expected to deactivate both the cell DTX operation and the cell DRX operation. If the field of the 1-bit parameter is set to a value (e.g., 1) representing the cell DTX operation, the UE may deactivate the cell DRX operation and activate the cell DTX operation. If the field of the 1-bit parameter is set to a value (e.g., 0) representing the cell DRX operation, the UE may deactivate the cell DTX operation and activate the cell DRX operation. In other words, the 1-bit parameter may be used to indicate to the UE to apply/activate either the cell DTX operation or the cell DRX operation.

Dependency with Other Signaling

In some implementations, when an SCell is configured and the cell-DTX/cell-DRX operation is configured for the SCell, if the SCell is activated, the UE may be implicitly indicated to activate the cell-DTX/cell-DRX operation for the SCell as well.

### On-Duration Periods of Cell-DTX/Cell-DRX

For a cell, when the cell DTX operation is configured and/or activated, the UE may determine the cell-DTX on-duration period. The UE may start the cell-DTX on-duration timer from the beginning of a subframe, where the number of the subframe satisfies the condition: [(SFN×10)+subframe number]modulo (the cell-DTX cycle)=the cell-DTX start offset.

For a cell, when the cell DRX operation is configured and/or activated, the UE may determine the cell-DRX on-duration period. The UE may start the cell-DRX on-duration timer from the beginning of a subframe, where the number of the subframe satisfies the condition: [(SFN×10)+subframe number]modulo (the cell-DRX cycle)=the cell-DRX start offset.

### Active/Non-Active Periods of Cell-DTX/Cell-DRX

For a cell, when the cell DTX operation is configured and/or activated, the cell-DTX active period may include the time (time span/time period/time duration) while one or more timers (e.g., the on-duration timer for the cell DTX operation) are running. When the cell DTX operation is configured and/or activated, the cell-DTX non-active period may include the time (time span/time period/time duration) while one or more timers (e.g., the on-duration timer for the cell DTX operation) are not running.

For a cell/NUL/SUL, when the cell DRX operation is configured and/or activated, the cell-DRX active period may include the time (time span/time period/time duration) while one or more timers (e.g., the on-duration timer for the cell DRX operation) are running. When the cell DRX operation is configured and/or activated, the cell-DRX non-active period may include the time while one or more timers (e.g., the on-duration timer for the cell DRX operation) are not running.

### Alignment Between Cell-DTX and DRX

For one or more serving cells, when both the cell DTX operation and the DRX operation (e.g., DRX at the UE) are configured and/or activated, the UE may be configured with parameters that are aligned with the cell DTX operation, such that the DRX on-duration determined by the parameters falls within the cell-DTX active period. To achieve this, one or more of the following mechanisms may be used/applied. In some implementations, the DRX mechanism may be the (cellular) DRX mechanism configured by the serving cell for the UE in the RRC Connected state via the RRCReconfiguration message.

### Aligned DRX Parameters

The UE may be configured by the network with the legacy DRX related parameters via RRC signaling. In some implementations, the UE may be configured via RRC signaling with a new set of the DRX related parameters that is aligned with the cell DTX operation. The value of parameters may be configured based on one or more rules below so that the DRX on-duration period determined by the new set of the DRX related parameters falls within the cell-DTX active period. The new set of DRX related parameters configured to be aligned with cell-DTX may be referred to as aligned DRX related parameters.

For a serving cell, when the cell-DTX and DRX are both configured, the aligned DRX on-duration timer may be configured as the same as, or less than, the cell-DTX on-duration timer.

For a serving cell, when the cell-DTX and DRX are both configured, the aligned DRX cycle may be configured as the same as, or a multiple of, the cell-DTX cycle.

For a serving cell, when the cell-DTX and DRX are both configured, the aligned DRX start offset may be configured as the same as the cell-DTX start offset.

For a serving cell, when the cell-DTX and DRX are both configured, the aligned DRX slot offset may be configured as the same as the cell-DTX slot offset.

Table 1 below illustrates a list of DRX related parameters aligned with the cell DTX operation, according to an example implementation of the present disclosure.

TABLE 1
DRX on-duration timer
If the cell-DTX on-duration timer is present, it may have the same value as or the value
less than the cell-DTX on-duration timer.
DRX cycle
If the cell-DTX cycle is present, it may have the same value as or a multiple of the cell-
DTX cycle.
DRX start offset
If the cell-DTX start offset is present, it may have the same value as the cell-DTX start
offset.
DRX slot offset
If the cell-DTX slot offset is present, it may have the same value as the cell-DTX slot
offset.

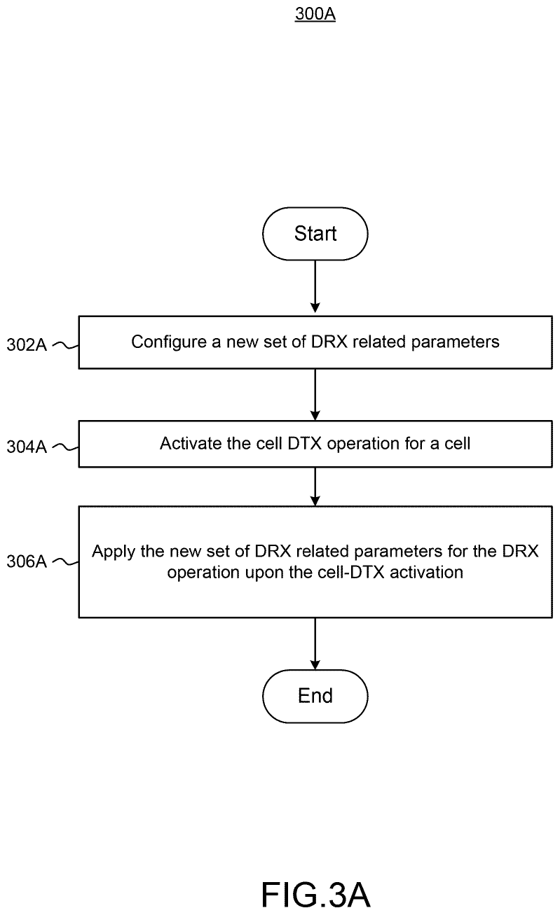

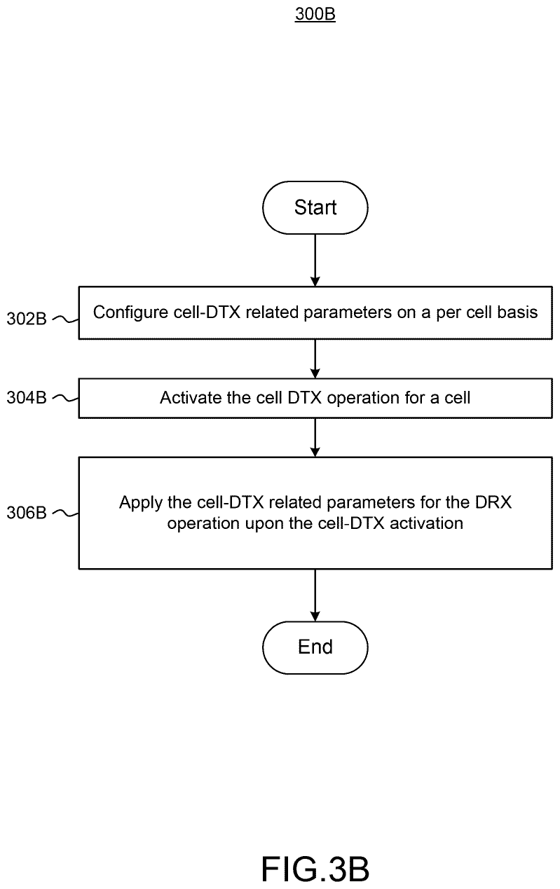

FIG. 3A is a flowchart illustrating a method/process 300A for aligning the DRX operation with the cell DTX operation, according to an example implementation of the present disclosure. In some implementations, the process 300A may be performed by a UE. In action 302A, the process 300A may start by configuring (e.g., according to Table 1 above) a new set of DRX related parameters. The new set of DRX related parameters may be configured on a per cell group basis or a per cell basis, in some implementations. In action 304A, the process 300A may activate the cell DTX operation for a cell. In action 306A, the process 300A may determine to apply the new set of DRX related parameters for the DRX operation upon the cell-DTX activation. The process 300A may then end.

In some implementations, the UE may be configured with a legacy set of DRX parameters as well. In some implementations, the UE may determine to apply the legacy set of DRX parameters when the cell DTX operation is deactivated.

In some implementation, if the aligned DRX related parameters associated with a serving cell are not provided/configured, the UE may apply the cell-DTX/cell-DRX related parameters configured for the cell as the aligned DRX related parameters. The cell-DTX/cell-DRX related parameters may include the cell-DTX/cell-DRX on-duration timer, the cell-DTX/cell-DRX cycle, the cell-DTX/cell-DRX start offset, and the cell-DTX/cell-DRX slot offset. The value of the aligned DRX related parameters may be configured based on one or more rules as described below.

For a serving cell, when the cell-DTX and DRX are configured, the configured DRX on-duration timer may be ignored if the cell DTX operation is activated. The UE may apply the cell-DTX on-duration timer corresponding to the cell-DTX configuration if the cell DTX operation is activated, or apply the DRX on-duration timer corresponding to the DRX configuration if the cell DTX operation is deactivated.

For a serving cell, when the cell-DTX and DRX are configured, the configured DRX cycle may be ignored. The UE may apply the cell-DTX cycle corresponding to the cell-DTX configuration if the cell DTX operation is activated, or apply the DRX cycle corresponding to the DRX configuration if the cell DTX operation is deactivated.

For a serving cell, when the cell-DTX and DRX are configured, the configured DRX start offset may be ignored. The UE may apply the cell-DTX start offset corresponding to the cell-DTX configuration if the cell DTX operation is activated, or apply the DRX start offset corresponding to the DRX configuration if the cell DTX operation is deactivated.

For a serving cell, when the cell-DTX and DRX are configured, the configured DRX slot offset may be ignored. The UE may apply the cell-DTX slot offset corresponding to the cell-DTX configuration if the cell DTX operation is activated, or apply the DRX slot offset corresponding to the DRX configuration if the cell DTX operation is deactivated.

Table 2 below illustrates a list of DRX related parameters aligned with the cell DTX operation, according to an example implementation of the present disclosure.

TABLE 2
DRX on-duration timer
If the cell-DTX on-duration timer is present, the UE may ignore this field. The UE may
apply the cell-DTX on-duration timer corresponding to the cell-DTX configuration if the
cell DTX operation is activated, or apply the DRX on-duration timer corresponding to the
DRX configuration if the cell DTX operation is deactivated.
DRX cycle
If the cell-DTX cycle is present, the UE may ignore this field. The UE may apply the cell-
DTX cycle corresponding to the cell-DTX configuration if the cell DTX operation is
activated, or apply the DRX cycle corresponding to the DRX configuration if the cell DTX
operation is deactivated.
DRX start offset
If the cell-DTX start offset is present, the UE may ignore this field. The UE may apply the
cell-DTX start offset corresponding to the cell-DTX configuration if the cell DTX
operation is activated, or apply the DRX start offset corresponding to the DRX
configuration if the cell DTX operation is deactivated.
DRX slot offset
If the cell-DTX slot offset is present, the UE may ignore this field. The UE may apply the
cell-DTX slot offset corresponding to the cell-DTX configuration if the cell DTX operation
is activated, or apply the DRX slot offset corresponding to the DRX configuration if the
cell DTX operation is deactivated.

In some implementations, the UE may apply the cell-DTX related parameters for the DRX operation (e.g., as shown in Table 2 above) when a new set of DRX related parameters is not configured. FIG. 3B is a flowchart illustrating a method/process 300B for aligning the DRX operation with the cell DTX operation, according to an example implementation of the present disclosure. In some implementations, the process 300B may be performed by a UE. In action 302B, the process 300B may start by configuring cell-DTX related parameters on a per cell basis in some implementations. In action 304B, the process 300B may activate the cell DTX operation for a cell. In action 306B, the process 300B may apply the cell-DTX related parameters for the DRX operation upon the cell-DTX activation. The process 300B may then end.

In some implementations, the UE may be configured with a legacy set of DRX parameters. In some implementations, the UE may determine to apply the legacy set of DRX parameters for the DRX operation when the cell DTX operation is deactivated.

When the DRX is configured, once the UE determines to apply one or more aligned DRX related parameters, the UE may perform one or more the following actions:
Stop one or more running DRX timers (e.g., the DRX on-duration/inactivity timer).
Stop using the current applied DRX cycle (e.g., the Long/Short DRX cycle);
Apply/select the aligned DRX on-duration timer as the DRX on-duration timer;
Apply/select one or more the aligned DRX related parameters, including the aligned DRX cycle, the aligned DRX start offset, and/or the aligned DRX slot offset, to determine when to start the DRX on-duration timer; and/or
Apply a scaling factor to the configured DRX related parameters. For instance, the scaling factor may be a value configured by an RRC configuration (e.g., together with the cell-DRX/cell-DTX configuration). The scaling factor may have an integer or a non-integer value. The DRX related parameters may include the DRX on-duration timer, the DRX cycle, the DRX start offset, and/or the DRX slot offset. In some implementations, the scaling factor may be configured per cell/cell group/BWP basis. In some implementations, the UE may be configured with a common/generic scaling factor for both the cell DTX operation and the cell DRX operation for a serving cell/a cell group. In some implementations, the scaling factor may include an aligned DRX related parameter. Once the cell DTX operation or the cell DRX operation is activated, the UE may determine whether to apply the aligned DRX related parameter (e.g., the scaling factor) based on the implementations, as described in this disclosure.

### Single Set of Aligned DRX Related Parameters (Per Cell Group)

When the UE is configured with multiple cells, the legacy DRX related parameters may be configured on a per cell group (e.g., DRX group) basis. In some implementations, the aligned DRX related parameters may be configured on a per cell group basis, indicating that the aligned DRX related parameters may be configured to be aligned with the cell DTX operation for each cell in the cell group. The aligned DRX related parameters may be associated with a cell group.

In some implementations, the aligned DRX related parameters associated with a cell group may be provided in the legacy DRX configuration (e.g., the DRX-Config).

In some implementations, the aligned DRX related parameters associated with a cell group may be provided in a new DRX configuration, which may be configured in a list of DRX configurations (e.g., the DRX-ConfigList).

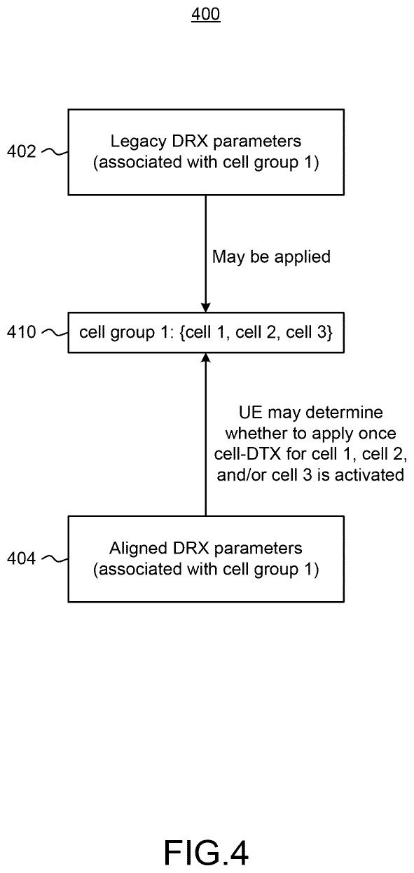

FIG. 4 is a diagram 400 illustrating a scenario in which the legacy DRX related parameters and the aligned DRX related parameters are configured, according to an example implementation of the present disclosure. The UE may be configured with the legacy DRX related parameters 402, which may be associated with the cell group 1. The UE may be also configured with the aligned DRX related parameters 404, which may be associated with the cell group 1 as well. As shown in block 410, the cell group 1 may include {cell 1, cell 2, cell 3}.

In some implementations, when the aligned DRX related parameters 404 associated with a cell group (e.g., the cell group 1) are configured/provided, if the cell DTX operation is activated for a cell in the cell group (e.g., cell 1, cell 2, or cell 3), the UE may determine whether to apply the aligned DRX related parameters 404 to perform the DRX operation (e.g., for determining the DRX on-duration period).

In some implementations, when the DRX is configured (e.g., the legacy DRX related parameters 402 are configured) and the aligned DRX related parameters 404 are configured for a cell group (e.g., the cell group 1), once the cell DTX operation is configured and/or activated for a cell in the cell group (e.g., cell 1, cell 2, or cell 3), the UE may apply the aligned DRX related parameters (e.g., including a cycle, a start offset, a slot offset, an on-duration timer) for determining the DRX on-duration period.

For example, when the DRX is configured (e.g., the legacy DRX related parameters 402 are configured), if the aligned DRX related parameters 404 (e.g., including a cycle, a start offset, a slot offset, an on-duration timer) are configured and associated with a cell group (e.g., the cell group 1) including {cell 1, cell 2, and cell 3}, once the cell DTX operation for any one cell of the cell group 1 (e.g., cell 1, cell 2, or cell 3) is activated, the UE may apply the aligned DRX related parameters 404 for performing the DRX operation for the cell group.

In some implementations, when the DRX is configured and the aligned DRX related parameters are configured, if the cell DTX operation is activated for one of the serving cells, the UE may be indicated to apply either the aligned DRX related parameters 404 or the legacy DRX related parameters 402 for performing the DRX operation (e.g., for determining the DRX on-duration period). The indication may be a 1-bit parameter provided in an RRC message/DCI/MAC CE.

For example, when the DRX is configured, if the aligned DRX related parameters 404 are configured and associated with the cell group 1, once the cell DTX operation for any one cell of the cell group 1 (e.g., cell 1, cell 2, or cell 3) is activated and the 1-bit parameter is set to a particular value (e.g., 1) indicating to the UE to apply the aligned DRX related parameters 404, the UE may apply the aligned DRX related parameters 404 for performing the DRX operation for the cell group 1; otherwise, the UE may apply the legacy DRX related parameters 402.

In some implementations, the UE may determine whether to apply the aligned DRX related parameters 404 to perform the DRX operation based on one or more pre-defined events. For example, when the DRX is configured and the aligned DRX related parameters 404 (e.g., including an aligned DRX cycle) associated with a cell group are configured, once the cell DTX operation for a cell in the cell group is activated, the UE may apply the aligned DRX cycle associated with the cell group as the (operating) DRX cycle if the current applied DRX cycle (e.g., the legacy DRX cycle) is not a multiple of the cell-DTX cycle for the cell; otherwise, the UE may not apply the aligned DRX cycle.

When the aligned DRX related parameters 404 associated with a cell group are configured/provided, if the cell DTX operation is deactivated for a cell, the UE may determine whether the aligned DRX related parameters 404 are applied/kept for performing the DRX operation (e.g., for determining the DRX on-duration period).

In some implementations, when the DRX is configured, once the cell DTX operation is deactivated for one of the serving cells, the UE may apply the legacy DRX related parameters 402 for performing the DRX operation (e.g., for determining the DRX on-duration period).

For example, when the DRX is configured, if the aligned DRX related parameters 404 are configured and associated with a cell group 1 including {cell 1, cell 2, and cell 3}, once the cell DTX operation for any one cell in the cell group 1 is deactivated, the UE may apply the legacy DRX related parameters 402 for performing the DRX operation for the cell group 1 including {cell 1, cell 2, cell 3}.

It should be noted that when the cell-DTX is deactivated for a cell, the cell-DTX for another cell may be activated. In some implementations, when the DRX is configured and the aligned DRX related parameters associated with a cell group are configured, if the cell DTX operation is deactivated for a cell in the cell group, the UE may be indicated to apply either the legacy DRX related parameters 402 or the aligned DRX related parameters 404 for performing the DRX operation (e.g., for determining the DRX on-duration period). The indication may be a 1-bit parameter provided in an RRC message/DCI/MAC CE.

For example, when the DRX is configured, if the aligned DRX related parameters 404 are configured and associated with a cell group 1 including {cell 1, cell 2, and cell 3}, once the cell DTX operation for any one cell in the cell group 1 is deactivated and the 1-bit parameter is set to a particular value (e.g., 1) indicating to the UE to apply the aligned DRX related parameters 404, the UE may apply the aligned DRX related parameters 404; otherwise, the UE may apply the legacy DRX related parameters 402.

It should be noted that the DRX mechanisms in this disclosure may include: the DRX mechanism configured to UEs in the RRC connected state; and the DRX/eDRX mechanism configured to UEs in the RRC idle/inactive state.

### Multiple Sets of Aligned DRX Related Parameters (Per Cell)

When the UE is configured with multiple (serving) cells, the cell DTX operation may be configured on a per cell basis. To provide high flexibility for configuration, the aligned DRX related parameters may be configured/provided/included in a configuration for a cell, indicating that the aligned DRX related parameters may be configured to be aligned with the cell DTX operation for at least this cell.

When the UE is configured with multiple cells, the UE may be configured with multiple sets of the aligned DRX related parameters, where each set of parameters may be associated with one of the configured cells. In some implementations, the aligned DRX related parameters may be configured in a cell-DTX configuration for a serving cell (e.g., PCell, SCell), indicating that the aligned DRX related parameters are associated with the serving cell.

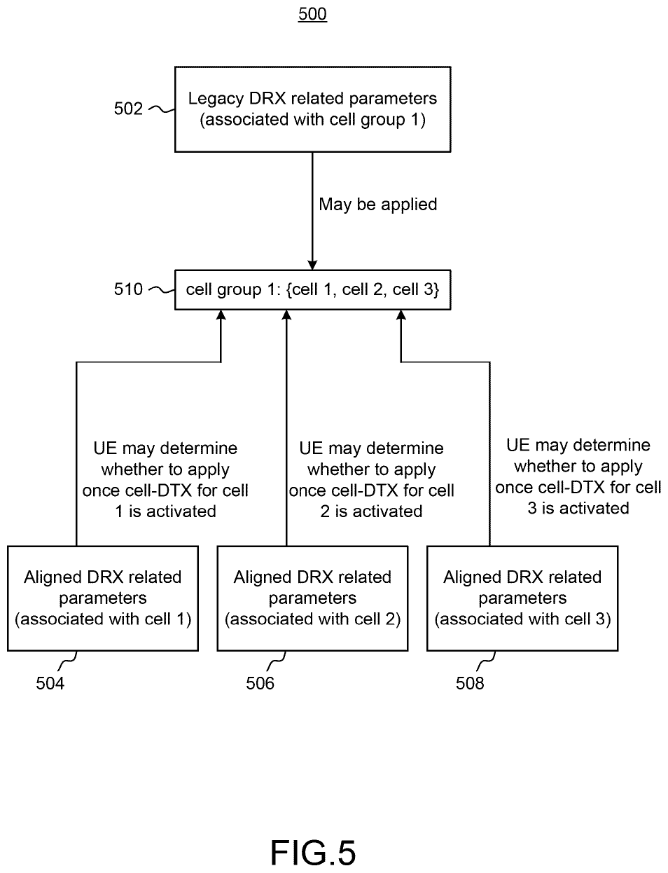

FIG. 5 is a diagram 500 illustrating a scenario in which the legacy DRX related parameters and multiple sets of aligned DRX related parameters are configured, according to an example implementation of the present disclosure. The UE may be configured with the legacy DRX related parameters 502, which may be associated with the cell group 1. As shown in block 510, the cell group 1 may include {cell 1, cell 2, cell 3}. The UE may also be configured with three sets of aligned DRX related parameters 504, 506, and 508, which may be associated with cell 1, cell 2, and cell 3, respectively. The aligned DRX related parameters 504 may be configured in the configuration for cell 1, indicating that the aligned DRX related parameters 504 are aligned with the cell DTX operation for cell 1 and are associated with cell 1. The aligned DRX related parameters 504 may or may not be aligned with the cell DTX operation for cell 2 and/or cell 3.

When the DRX is configured and a set of aligned DRX related parameters 504 associated with cell 1 are configured/provided, if the cell DTX operation is activated for the cell 1, the UE may determine whether to apply the aligned DRX related parameters 504 for performing the DRX operation (e.g., for determining the DRX on-duration period) for a DRX group.

In some implementations, when the DRX is configured and the aligned DRX related parameters associated with a cell are configured, once the cell DTX operation is activated for the cell, the UE may apply the aligned DRX related parameters for performing the DRX operation (e.g., for determining the DRX on-duration period) for a DRX group.

For example, when the UE is configured with multiple serving cells including {cell 1, cell 2, and cell 3}, if DRX is configured and the aligned DRX related parameters 504 (e.g., including a cycle, a start offset, a slot offset, an on-duration timer) are configured and associated with cell 1, once the cell DTX operation for cell 1 is activated, the UE may apply the aligned DRX related parameters 504 for performing the DRX operation for the cell group including {cell 1, cell 2, and cell 3}. In some implementations, the values of the aligned DRX related parameters 504 associated with cell 1 may be set/configured to be aligned with the cell DTX operation for cell 1, cell 2, and/or cell 3.

In some implementations, the UE may determine whether to apply the aligned DRX related parameters 504 for performing the DRX operation based on one or more pre-defined events. For example, when the DRX is configured and the aligned DRX related parameters 504 (e.g., including an aligned DRX cycle) associated with cell 1 are configured, once the cell DTX operation for the cell 1 is activated, the UE may apply the aligned DRX cycle associated with the cell 1 as the (operating) DRX cycle if the current applied DRX cycle is not a multiple of the cell-DTX cycle for the cell 1; otherwise, the UE may not apply the aligned DRX cycle. The current applied DRX cycle may be a legacy DRX cycle or an aligned DRX cycle associated with one of the configured serving cells.

In some implementations, when the DRX is configured and the aligned DRX related parameters (e.g., including an aligned DRX cycle) associated with a cell are configured, once the cell DTX operation for the cell is activated, the UE may apply the aligned DRX related parameters associated with the cell if the current applied DRX related parameters is not associated with any serving cell; otherwise, the UE may not apply the aligned DRX related parameters.

It should be noted that cell-DTX for a cell may have been activated and the aligned DRX related parameters associated with the cell may have been applied when cell-DTX for another cell is activated. In some implementations, if cell-DTX is activated for a cell, the UE may determine whether to apply the aligned DRX related parameters associated with the cell for performing the DRX operation (e.g., for determining the DRX on-duration period) for a DRX group.

In some implementations, the determination may be based on a 1-bit parameter, where the 1-bit parameter may be included in an RRC message/MAC CE/DCI. For example, when the DRX is configured and the aligned DRX related parameters associated with a cell are configured, once cell-DTX for the cell is activated and the 1-bit parameter is provided, if the 1-bit parameter is set to a value (e.g., 1) indicating to the UE to apply the aligned DRX related parameter, the UE may apply the aligned DRX related parameters associated with the cell for performing the DRX operation for a DRX group; otherwise, the UE may not apply the aligned DRX related parameters.

In some implementations, the determination may be based on an order of cell priorities, where the order may be configured/provided by the network via RRC signaling. For example, when the DRX is configured and the UE has applied the aligned DRX related parameters 504 associated with the cell 1 for performing the DRX operation for a DRX group, if the cell DTX operation for the cell 2 is activated and the priority of the cell 2 is higher than the priority of the cell 1 based on the configured cell priority order, the UE may apply the aligned DRX related parameters 506 associated with the cell 2 for performing the DRX operation for the DRX group; otherwise the UE may not apply the aligned DRX related parameters 506. The priority of a cell may be an absolute priority configured by an integer parameter (e.g., CellDTXCellPriority) ranged from 0 to the maximum number of configured cells included in a cell configuration. The priority having the value 0 may mean the lowest priority.

When the DRX is configured and the cell DTX operation is deactivated for/by the (serving) cell (or by the serving RAN), the UE may determine whether to apply the legacy DRX related parameters 502 to perform the DRX operation (e.g., for determining the DRX on-duration period) for a DRX group.

In some implementations, when the DRX is configured, once the cell DTX operation for a cell is deactivated, the UE may apply the legacy DRX related parameters 502 for performing the DRX operation for a DRX group.

In some implementations, when the DRX is configured, if the cell DTX operation for a cell is deactivated, the UE may be indicated whether to apply the legacy DRX related parameters 502 for performing the DRX operation for a DRX group.

The indication may be a 1-bit parameter provided in an RRC message/DCI/MAC CE. For example, when the DRX is configured, once the cell DTX operation for a cell is deactivated, if the 1-bit parameter is set to a value (e.g., 1) indicating to the UE to apply the legacy DRX related parameters 502, the UE may apply the legacy DRX related parameters 502 for a DRX group; otherwise, the UE may not apply the legacy DRX related parameters 502.

In some implementations, when the DRX is configured and the aligned DRX related parameters 504 associated with the cell 1 are configured/provided, once the cell DTX operation for the cell 2 is deactivated, the UE may be indicated to apply the aligned DRX related parameters 504 associated with the cell 1 for performing the DRX operation for a DRX group.

For example, the indication may be an integer parameter (e.g., having 32 bits) included in an RRC message/MAC CE/DCI, indicating to the UE to apply the aligned DRX related parameters associated with the cell with the index equal to the value of the integer parameter.

In some implementations, a serving cell (e.g., a secondary cell) may be activated and the UE may work on a ‘dormant’ (DL) BWP configured by the serving RAN. In this condition, the UE may implement the cell DTX/cell-DRX mechanism on the dormant (DL) BWP. The UE may not monitor the PDCCHs on the serving cell since there is no PDCCH configuration on the dormant (DL) BWP.

In some implementations, the existing dormant (DL) BWP implementations may or may not override the cell-DRX/cell-DTX operation at the UE side. In some implementations, the disclosed cell-DTX/cell-DRX operation may or may not override the dormant (DL) BWP implementations.

Enhanced DRX Operations to Align with Cell-DTX

In some implementations, when the DRX is configured for a cell group (e.g., DRX group) and the Short DRX cycle is configured, the UE may stop the DRX short cycle timer. The UE may use a specific cycle for the cell group if any cell in the cell group is configured with the cell DTX operation and a cell-DTX timer (e.g., the cell-DTX on-duration timer) for the cell expires. The specific cycle may be the Long DRX cycle for the cell group, the aligned DRX cycle for the cell, the cell-DTX cycle for the cell, or the common/generic cycle for cell-DTX/cell-DRX for the cell.

In some implementations, when the DRX is configured for a cell group (e.g., DRX group) and the Short DRX cycle is configured, the UE may stop the DRX short cycle timer. The UE may use a specific cycle for the cell group if all cells are configured with the cell DTX operation in the cell group and the cell-DTX timer (e.g., the cell-DTX on-duration timer) for each cell expires. The specific cycle may be the Long DRX cycle for the cell group, the aligned DRX cycle for the cell, the cell-DTX cycle for the cell, or the common/generic cycle for cell-DTX/cell-DRX for the cell.

In some implementations, when the DRX is configured for a cell group, the UE may stop all DRX timers and release the legacy DRX configuration once the cell DTX is configured and/or activated for a cell in the cell group.

In some implementations, when the DRX is configured for a cell group, the UE may start the DRX on-duration timer once one or more cell-DTX timers for a cell in the cell group are started.

In some implementations, when the DRX is configured for a cell group, the UE may stop the DRX on-duration/inactivity timer if one or more cell-DTX timers for a cell in the cell group are stopped.

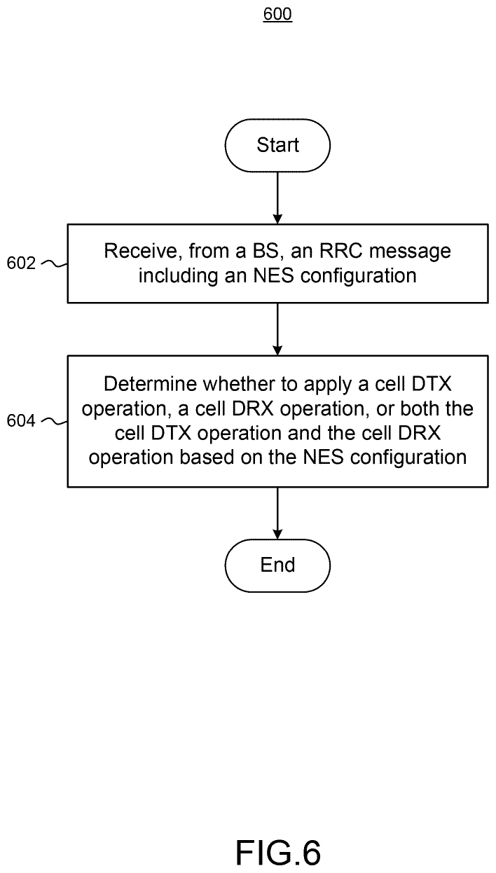

FIG. 6 is a flowchart illustrating a method/process 600 performed by a UE for NES, according to an example implementation of the present disclosure. In the action 602, the process 600 may start by receiving, from a BS, an RRC message including an NES configuration. In the action 604, the process 600 may determine whether to apply a cell DTX operation, a cell DRX operation, or both the cell DTX operation and the cell DRX operation based on the NES configuration. The process 600 may then end.

In some implementations, the NES configuration may be included in a cell configuration carried by the RRC message. The cell DTX operation, the cell DRX operation, or both the cell DTX operation and the cell DRX operation may be applied to a cell associated with the cell configuration. In other words, the cell DTX operation and the cell DRX operation may be configured on a per cell basis.

In some implementations, the UE may be served by multiple cells (e.g., PCell, SCell, and PSCell). The cell DTX operation, the cell DRX operation, or both the cell DTX operation and the cell DRX operation may be applied to one of the cells serving the UE.

In some implementations, the NES configuration may include a set of common parameters applicable to both the cell DTX operation and the cell DRX operation. In some implementations, the set of common parameters may include an on-duration timer, a cycle, a start offset, and a slot offset.

In some implementations, the UE may determine a first on-duration period for the cell DTX operation and a second on-duration period for the cell DRX operation based on the set of common parameters. In other words, the cell-DTX on-duration period and the cell-DRX on-duration period may be determined based on the same set of common parameters. In addition, the BS may also determine the first on-duration period for the cell DTX operation and the second on-duration period for the cell DRX operation based on the set of common parameters.

In some implementations, the NES configuration may include a parameter for indicating whether to apply the cell DTX operation, the cell DRX operation, or both the cell DTX operation and the cell DRX operation. For example, the parameter may have at least three different values for indicating these three different functions.

The technical problem addressed by the method illustrated in FIG. 6 is how to efficiently provide a configuration for network energy saving, particularly for the cell DTX operation and the cell DRX operation. The cell DTX operation and the cell DRX operation may be configured based on the same set of common parameters. In addition, a single parameter may indicate whether to apply the cell DTX operation, the cell DRX operation, or both the cell DTX operation and the cell DRX operation. This method may help to improve the overall performance of the wireless communication system by reducing the signaling overhead, leading to enhanced NES performance.

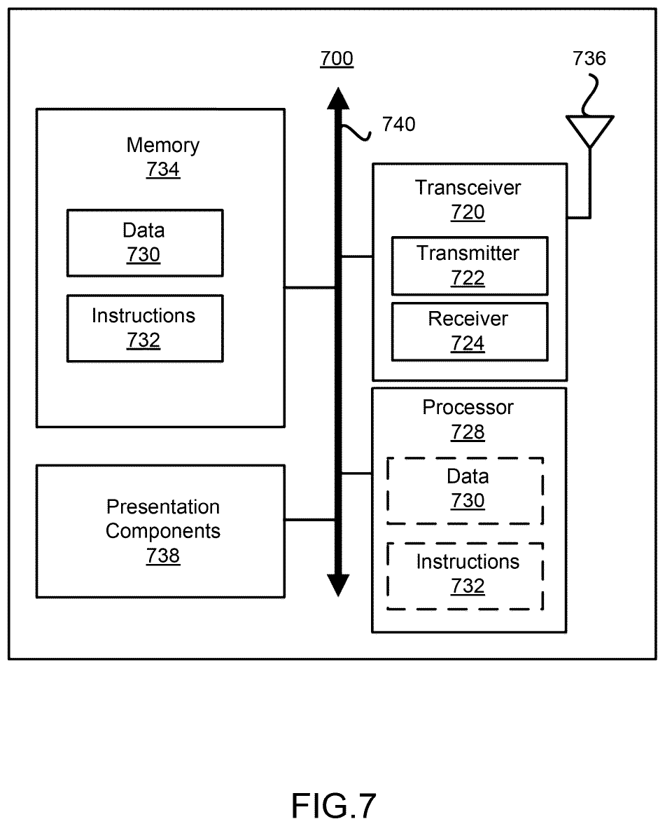

FIG. 7 is a block diagram illustrating a node 700 for wireless communication in accordance with various aspects of the present disclosure. As illustrated in FIG. 7, a node 700 may include a transceiver 720, a processor 728, a memory 734, one or more presentation components 738, and at least one antenna 736. The node 700 may also include a radio frequency (RF) spectrum band module, a BS communications module, a network communications module, and a system communications management module, Input/Output (I/O) ports, I/O components, and a power supply (not illustrated in FIG. 7).

Each of the components may directly or indirectly communicate with each other over one or more buses 740. The node 700 may be a UE or a BS that performs various functions disclosed with reference to FIGS. 1 through 6.

The transceiver 720 has a transmitter 722 (e.g., transmitting/transmission circuitry) and a receiver 724 (e.g., receiving/reception circuitry) and may be configured to transmit and/or receive time and/or frequency resource partitioning information. The transceiver 720 may be configured to transmit in different types of subframes and slots including, but not limited to, usable, non-usable, and flexibly usable subframes and slot formats. The transceiver 720 may be configured to receive data and control channels.

The node 700 may include a variety of computer-readable media. Computer-readable media may be any available media that may be accessed by the node 700 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the above listed components should also be included within the scope of computer-readable media.

The memory 734 may include computer-storage media in the form of volatile and/or non-volatile memory. The memory 734 may be removable, non-removable, or a combination thereof. Example memory may include solid-state memory, hard drives, optical-disc drives, etc. As illustrated in FIG. 7, the memory 734 may store a computer-readable and/or computer-executable instructions 732 (e.g., software codes) that are configured to, when executed, cause the processor 728 to perform various functions disclosed herein, for example, with reference to FIGS. 1 through 6. Alternatively, the instructions 732 may not be directly executable by the processor 728 but may be configured to cause the node 700 (e.g., when compiled and executed) to perform various functions disclosed herein.

The processor 728 (e.g., having processing circuitry) may include an intelligent hardware device, e.g., a Central Processing Unit (CPU), a microcontroller, an ASIC, etc. The processor 728 may include memory. The processor 728 may process the data 730 and the instructions 732 received from the memory 734, and information transmitted and received via the transceiver 720, the baseband communications module, and/or the network communications module. The processor 728 may also process information to send to the transceiver 720 for transmission via the antenna 736 to the network communications module for transmission to a CN.

One or more presentation components 738 may present data indications to a person or another device. Examples of presentation components 738 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a User Equipment (UE) for Network Energy Saving (NES), the method comprising:
receiving, from a Base Station (BS), a Radio Resource Control (RRC) message comprising an NES configuration; and
determining whether to apply a cell Discontinuous Transmission (DTX) operation, a cell Discontinuous Reception (DRX) operation, or both the cell DTX operation and the cell DRX operation based on the NES configuration.

2. The method of claim 1, wherein:
the NES configuration is included in a cell configuration carried by the RRC message, and
the cell DTX operation, the cell DRX operation, or both the cell DTX operation and the cell DRX operation is/are applied to a cell associated with the cell configuration.

3. The method of claim 1, wherein:
the UE is served by a plurality of cells, and
the cell DTX operation, the cell DRX operation, or both the cell DTX operation and the cell DRX operation is/are applied to one of the plurality of cells serving the UE.

4. The method of claim 1, wherein:
the NES configuration comprises a set of common parameters applicable to both the cell DTX operation and the cell DRX operation.

5. The method of claim 4, wherein:
the set of common parameters comprises at least one of an on-duration timer, a cycle, a start offset, and a slot offset.

6. The method of claim 4, further comprising:
determining a first on-duration period for the cell DTX operation and a second on-duration period for the cell DRX operation based on the set of common parameters.

7. The method of claim 1, wherein:
the NES configuration comprises a parameter for indicating whether to apply the cell DTX operation, the cell DRX operation, or both the cell DTX operation and the cell DRX operation.

8. A User Equipment (UE) for performing Network Energy Saving (NES), the UE comprising:
at least one processor; and
at least one non-transitory computer-readable medium storing one or more computer-executable instructions that, when executed by the at least one processor, cause the UE to:
receive, from a Base Station (BS), a Radio Resource Control (RRC) message comprising an NES configuration; and
determine whether to apply a cell Discontinuous Transmission (DTX) operation, a cell Discontinuous Reception (DRX) operation, or both the cell DTX operation and the cell DRX operation based on the NES configuration.

9. The UE of claim 8, wherein:
the NES configuration is included in a cell configuration carried by the RRC message, and
the cell DTX operation, the cell DRX operation, or both the cell DTX operation and the cell DRX operation is/are applied to a cell associated with the cell configuration.

10. The UE of claim 8, wherein:
the UE is served by a plurality of cells, and
the cell DTX operation, the cell DRX operation, or both the cell DTX operation and the cell DRX operation is/are applied to one of the plurality of cells serving the UE.

11. The UE of claim 8, wherein:
the NES configuration comprises a set of common parameters applicable to both the cell DTX operation and the cell DRX operation.

12. The UE of claim 11, wherein:
the set of common parameters comprises an on-duration timer, a cycle, a start offset, and a slot offset.

13. The UE of claim 11, wherein the one or more computer-executable instructions, when executed by the at least one processor, further cause the UE to:
determine a first on-duration period for the cell DTX operation and a second on-duration period for the cell DRX operation based on the set of common parameters.

14. The UE of claim 8, wherein:
the NES configuration comprises a parameter for indicating whether to apply the cell DTX operation, the cell DRX operation, or both the cell DTX operation and the cell DRX operation.

15. A Base Station (BS) for performing Network Energy Saving (NES), the BS comprising:
at least one processor; and
at least one non-transitory computer-readable medium storing one or more computer-executable instructions that, when executed by the at least one processor, cause the BS to:
transmit, to a User Equipment (UE), a Radio Resource Control (RRC) message comprising an NES configuration,
wherein the NES configuration indicates to the UE whether to apply a cell Discontinuous Transmission (DTX) operation, a cell Discontinuous Reception (DRX) operation, or both the cell DTX operation and the cell DRX operation.

16. The BS of claim 15, wherein:
the NES configuration is included in a cell configuration carried by the RRC message, and
the cell DTX operation, the cell DRX operation, or both the cell DTX operation and the cell DRX operation is/are applied to a cell associated with the cell configuration.

17. The BS of claim 15, wherein:
the UE is served by a plurality of cells, and
the cell DTX operation, the cell DRX operation, or both the cell DTX operation and the cell DRX operation is/are applied to one of the plurality of cells serving the UE.

18. The BS of claim 15, wherein:
the NES configuration comprises a set of common parameters applicable to both the cell DTX operation and the cell DRX operation.

19. The BS of claim 18, wherein:
the set of common parameters comprises an on-duration timer, a cycle, a start offset, and a slot offset.

20. The BS of claim 18, wherein the one or more computer-executable instructions, when executed by the at least one processor, further cause the BS to:
determine a first on-duration period for the cell DTX operation and a second on-duration period for the cell DRX operation based on the set of common parameters.
